(19) United States
(12) Patent Application Publication
(10) Pub. No.: US 2015/0072078 A1
(43) Pub. Date: Mar. 12, 2015

(54) SUBSTRATE TREATMENT METHOD AND SUBSTRATE TREATMENT APPARATUS

(71) Applicant: DAINIPPON SCREEN MFG. CO., LTD., Kyoto (JP)

(72) Inventors: Sei NEGORO, Kyoto (JP); Yasuhiko NAGAI, Kyoto (JP); Keiji IWATA, Kyoto (JP); Tsutomu OSUKA, Kyoto (JP); Ryo MURAMOTO, Kyoto (JP)

(21) Appl. No.: 14/462,717

(22) Filed: Aug. 19, 2014

(30) Foreign Application Priority Data
Sep. 10, 2013 (JP) 2013-187626

(51) Int. Cl. B05C 9/14; B05C 9/12; B05D 3/02; B05C 11/08; B05D 1/00; B05B 12/00

(52) U.S. Cl. CPC B05C 9/14; B05D 1/005; B05B 12/00; B05D 3/0254; B05C 11/08; B05C 9/12
USPC 427/346; 118/697

(57) ABSTRACT

A substrate treatment method is provided which includes: a treatment liquid supplying step of supplying a treatment liquid to a major surface of a substrate; a substrate rotating step of rotating the substrate while retaining a liquid film of the treatment liquid on the major surface of the substrate; a heater heating step of locating a heater in opposed relation to the major surface of the substrate to heat the treatment liquid film by the heater in the substrate rotating step; and a heat amount controlling step of controlling the amount of heat to be applied per unit time to a predetermined portion of the liquid film from the heater according to the rotation speed of the substrate in the heater heating step.

### BACKGROUND OF THE INVENTION

1. Field of the Invention

The present invention relates to a substrate treatment method and a substrate treatment apparatus. Exemplary substrates to be treated include semiconductor wafers, substrates for liquid crystal display devices, substrates for plasma display devices, substrates for FED (Field Emission Display) devices, substrates for optical disks, substrates for magnetic disks, substrates for magneto-optical disks, substrates for photo masks, ceramic substrates and substrates for solar cells.

2. Description of Related Art

Semiconductor device production processes include the step of locally implanting an impurity (ions) such as phosphorus, arsenic or boron, for example, into a front surface of a semiconductor substrate (hereinafter referred to simply as “wafer”). In order to prevent the ion implantation into an unnecessary portion of the wafer, a resist pattern of a photosensitive resin is formed on the front surface of the wafer to mask the unnecessary portion of the wafer with the resist in this step. After the ion implantation, the resist pattern formed on the front surface of the wafer becomes unnecessary and, therefore, a resist removing process is performed for removing the unnecessary resist.

In a typical example of the resist removing process, the front surface of the wafer is irradiated with oxygen plasma to ash the resist on the front surface of the wafer. Then, a chemical liquid such as a sulfuric acid/hydrogen peroxide mixture (SPM liquid which is a liquid mixture of sulfuric acid and a hydrogen peroxide solution) is supplied to the front surface of the wafer to remove the asked resist. Thus, the resist is removed from the front surface of the wafer.

However, the irradiation with the oxygen plasma for the ashing of the resist damages a portion of the front surface of the wafer uncovered with the resist (e.g., an oxide film exposed from the resist).

Therefore, a method of lifting off the resist from the front surface of the wafer by the strong oxidative power of peroxosulfuric acid (H₂SO₅) contained in the SPM liquid supplied onto the front surface of the wafer without ashing the resist has recently been attracting attention (see, for example, JP2005-32819A).

### SUMMARY OF THE INVENTION

A resist formed on the wafer subjected to ion implantation at a higher dose is liable to be altered (hardened).

One method of imparting the SPM liquid with a higher resist lift-off capability is to heat the SPM liquid on the front surface of the wafer, particularly a portion of the SPM liquid present around an interface between the front surface of the wafer and the SPM liquid, to a higher temperature (e.g., 200° C. or higher). With this method, even a resist having a hardened surface layer can be removed from the front surface of the wafer without the ashing. One conceivable method for keeping the SPM liquid at a higher temperature around the interface between the front surface of the wafer and the SPM liquid is to continuously supply the higher temperature SPM liquid to the wafer. However, this method increases the use amount of the SPM liquid.

The inventors of the present invention contemplate to cover the entire front surface of the wafer with a liquid film of the treatment liquid, while heating the treatment liquid film by means of a heater located in opposed relation to the front surface of the wafer. More specifically, a heater having a smaller diameter than the front surface of the wafer is employed as the heater, and the heater is moved along the front surface of the wafer, for example, at a constant speed while being energized for heating. The amount of heat applied from the heater during the heating is kept constant. This arrangement makes it possible to remove the hardened resist from the wafer while reducing the consumption of the treatment liquid. In addition, the resist lift-off efficiency can be significantly increased, thereby reducing the process time required for the resist lift-off process.

If the liquid film heated on the major surface (front surface) of the substrate (wafer) by the heater has a smaller thickness, however, the major surface of the substrate is likely to be damaged. If the liquid film has a greater thickness, on the other hand, the liquid film absorbs the heat applied from the heater. Therefore, the heat does not reach the treatment liquid portion present around the interface between the major surface of the substrate and the liquid film, failing to sufficiently increase the temperature of the treatment liquid portion. That is, there is a demand for advantageously treating the major surface of the substrate with the use of the heater without damaging the major surface.

It is therefore an object of the present invention to provide a substrate treatment method and a substrate treatment apparatus which ensure that a major surface of a substrate can be advantageously treated with the use of a heater without any damage thereto.

According to the present invention, there is provided a substrate treatment method, which includes: a treatment liquid supplying step of supplying a treatment liquid to a major surface of a substrate; a substrate rotating step of rotating the substrate while retaining a liquid film of the treatment liquid on the major surface of the substrate; a heater heating step of locating a heater in opposed relation to the major surface of the substrate to heat the treatment liquid film by the heater in the substrate rotating step; and a heat amount controlling step of controlling the amount of heat to be applied per unit time to a predetermined portion of the liquid film from the heater according to the rotation speed of the substrate in the heater heating step.

In this method, the heat is applied to the predetermined portion of the liquid film retained on the major surface of the substrate from the heater, and the heat amount per unit time is controlled according to the rotation speed of the substrate. The thickness of the liquid film present on the major surface of the substrate varies depending on the rotation speed of the substrate. Therefore, the amount of the heat to be applied per unit time to the predetermined portion of the liquid film from the heater can be adapted for the thickness of the liquid film. Thus, even if the thickness of the liquid film present on the major surface of the substrate varies due to a change in the rotation speed of the substrate, overheating of the major surface of the substrate and insufficient heating of the treatment liquid are prevented. As a result, the major surface of the substrate can be advantageously treated with the use of the heater without any damage thereto.

According to one embodiment of the present invention, the heat amount controlling step includes a heater output controlling step of controlling the output of the heater according to the rotation speed of the substrate.

In this method, the output of the heater is controlled according to the rotation speed of the substrate. Therefore, the output of the heater can be adapted for the thickness of the liquid film present on the major surface of the substrate. Therefore, even if the thickness of the treatment liquid film varies due to the change in the rotation speed of the substrate, the overheating of the major surface of the substrate and the insufficient heating of the treatment liquid are prevented. As a result, the major surface of the substrate can be advantageously treated with the use of the heater without any damage thereto.

The substrate treatment method may further include a heater moving step of moving the heater along the major surface of the substrate, and the heat amount controlling step may include a heater moving speed controlling step of controlling the moving speed of the heater according to the rotation speed of the substrate.

In this method, the heater is moved along the major surface of the substrate in the heater moving step. The heater moving speed is controlled according to the rotation speed of the substrate. Therefore, the heater moving speed can be adapted for the thickness of the liquid film present on the major surface of the substrate. The amount of the heat to be applied to the predetermined portion of the liquid film can be relatively reduced by increasing the heater moving speed, and relatively increased by reducing the heater moving speed. Therefore, even if the thickness of the treatment liquid film varies due to the change in the rotation speed of the substrate, local overheating of the major surface of the substrate and the insufficient heating of the treatment liquid are prevented. As a result, the major surface of the substrate can be advantageously treated with the use of the heater without any damage thereto.

The heat amount controlling step may include the step of determining the heat amount per unit time based on a relational table indicating a relationship between the rotation speed of the substrate and the amount of the heat to be applied per unit time from the heater.

In this method, the heat amount per unit time is determined based on the relational table indicating the relationship between the rotation speed of the substrate and the amount of the heat to be applied per unit time from the heater. Since the relationship between the rotation speed of the substrate and the amount of the heat to be applied per unit time from the heater is preliminarily specified in the relational table, the heat amount suitable for the rotation speed of the substrate can be applied to the liquid film present on the major surface of the substrate.

The heat amount controlling step may include the step of referring to a recipe stored in a recipe storing unit and determining the heat amount per unit time based on a rotation speed of the substrate specified in the recipe to be employed in the substrate rotating step.

In this method, the heat amount per unit time is determined based on information of the substrate rotation speed contained in the recipe for a substrate treatment process in the heat amount controlling step. Therefore, the heat amount suitable for the rotation speed of the substrate can be applied to the liquid film present on the major surface of the substrate.

The treatment liquid may include a resist lift-off liquid containing sulfuric acid.

In this method, where a resist is provided on the major surface of the substrate, a liquid including the resist lift-off liquid containing sulfuric acid is used as the treatment liquid. In this case, the resist lift-off liquid containing sulfuric acid can be heated to a higher temperature on the major surface of the substrate by the heater. Thus, even if the resist has a hardened surface layer, the resist can be removed from the major surface of the substrate without ashing thereof.

The amount of the heat to be applied per unit time to the predetermined portion of the liquid film of the resist lift-off liquid can be adapted for the thickness of the liquid film. Therefore, even if the thickness of the resist lift-off liquid film varies due to the change in the rotation speed of the substrate, the overheating of the major surface of the substrate and the insufficient heating of the treatment liquid are prevented. As a result, the resist can be efficiently lifted off from the major surface of the substrate without damaging the major surface of the substrate.

The treatment liquid may include a chemical liquid containing an ammonia water.

According to the present invention, there is also provided a substrate treatment apparatus, which includes: a substrate holding unit which holds a substrate; a substrate rotating unit which rotates the substrate held by the substrate holding unit; a treatment liquid supplying unit which supplies a treatment liquid to a major surface of the substrate held by the substrate holding unit; a heater to be located in opposed relation to the major surface of the substrate; and a control unit which controls the substrate rotating unit and the heater to perform a substrate rotating step of rotating the substrate while retaining a liquid film of the treatment liquid on the major surface of the substrate, a heater heating step of heating the treatment liquid film by the heater in the substrate rotating step, and a heat amount controlling step of controlling the amount of heat to be applied per unit time to a predetermined portion of the liquid film from the heater according to the rotation speed of the substrate in the heater heating step.

With this arrangement, the heat is applied to the predetermined portion of the liquid film retained on the major surface of the substrate from the heater. The heat amount per unit time is controlled according to the rotation speed of the substrate. The thickness of the liquid film present on the major surface of the substrate varies depending on the rotation speed of the substrate. Therefore, the amount of the heat to be applied per unit time to the predetermined portion of the liquid film can be adapted for the thickness of the liquid film. Thus, even if the thickness of the liquid film present on the major surface of the substrate varies due to a change in the rotation speed of the substrate, overheating of the major surface of the substrate and insufficient heating of the treatment liquid are prevented. As a result, the major surface of the substrate can be advantageously treated with the use of the heater without any damage thereto.

The foregoing and other objects, features and effects of the present invention will become more apparent from the following detailed description of the preferred embodiments with reference to the attached drawings.

### BRIEF DESCRIPTION OF THE DRAWINGS

FIG. 1A is a schematic plan view showing the schematic construction of a substrate treatment apparatus according to a first embodiment of the present invention.

FIG. 1B is a diagram schematically showing the construction of a treatment unit of the substrate treatment apparatus.

FIG. 2 is a schematic sectional view of a heater shown in FIG. 1B.

FIG. 3 is a perspective view of an infrared lamp shown in FIG. 2.

FIG. 4 is a perspective view of a heater arm and the heater shown in FIG. 1B.

FIG. 5 is a plan view showing the positions of the heater.

FIG. 6 is a block diagram showing the electrical construction of the substrate treatment apparatus.

FIG. 7 is a flow chart showing a first exemplary resist removing process according to the first embodiment of the present invention.

FIG. 8 is a time chart for explaining major steps of the exemplary process shown in FIG. 7.

FIGS. 9A to 9C are schematic diagrams for explaining process steps of the first exemplary process.

FIG. 10 is a flow chart showing how to control power supply to the heater.

FIG. 11 is a time chart for explaining an SC1 supplying/heater heating step of the first exemplary process.

FIG. 12 is a time chart showing a second exemplary resist removing process according to the first embodiment of the present invention.

FIG. 13 is a block diagram showing the electrical construction of a substrate treatment apparatus according to a second embodiment of the present invention.

FIG. 14 is a flowchart showing a third exemplary resist removing process according to the second embodiment of the present invention.

FIG. 15 is a time chart for explaining an SPM liquid film forming step and an SPM liquid film heating step of the third exemplary process.

FIG. 16 is a flow chart showing how to control a heater moving speed.

FIG. 17 is a time chart for explaining an SC1 supplying/heater heating step of the third exemplary process.

FIG. 18 is a time chart showing a fourth exemplary resist removing process according to the second embodiment of the present invention.

### DETAILED DESCRIPTION OF PREFERRED EMBODIMENTS

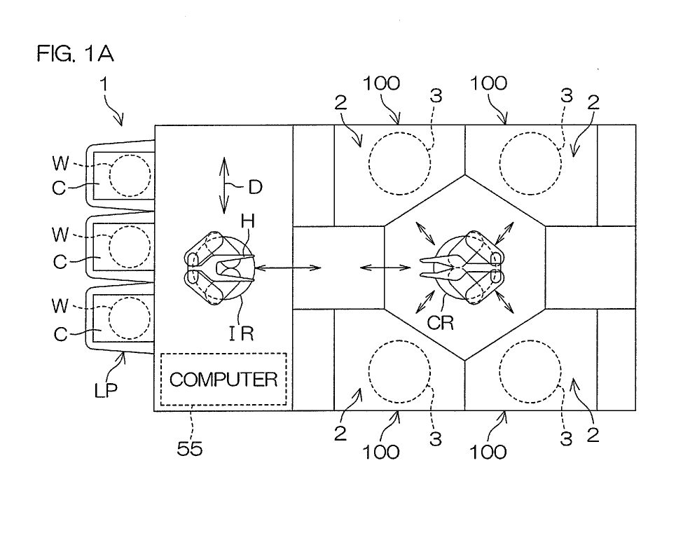

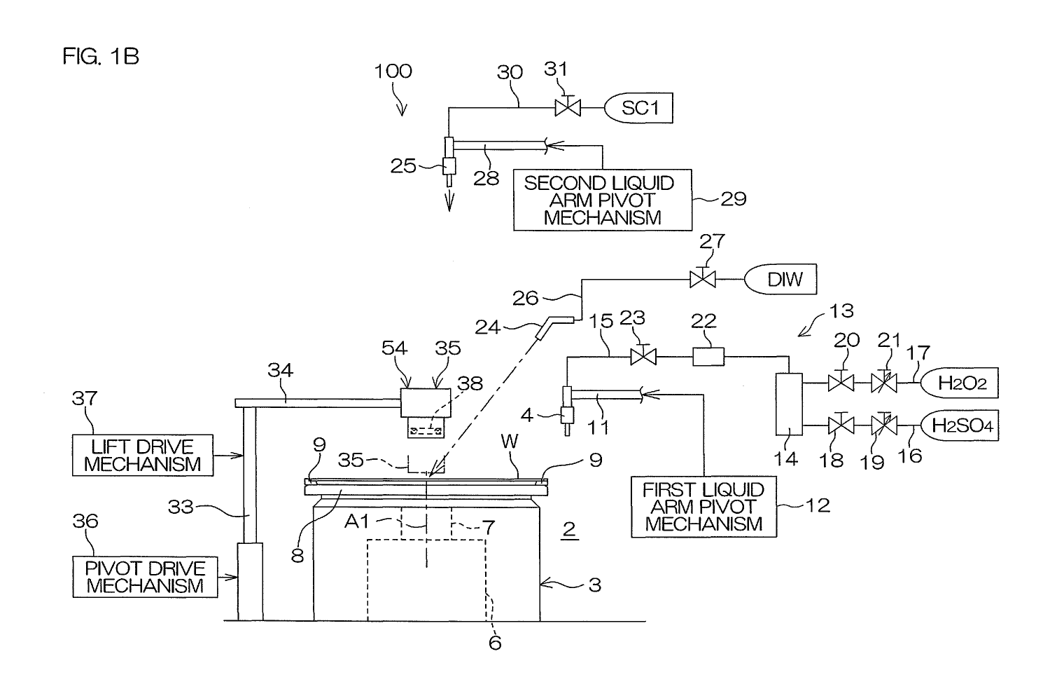

FIG. 1A is a schematic plan view showing the schematic construction of a substrate treatment apparatus 1 according to a first embodiment of the present invention. As shown in FIG. 1A, the substrate treatment apparatus 1 is of a single substrate treatment type to be used for removing an unnecessary resist from a front surface (major surface) of a wafer W (exemplary substrate) after being subjected to an ion implantation process for implanting an impurity into the front surface of the wafer W or a dry etching process.

The substrate treatment apparatus 1 includes a load port LP serving as a container retaining unit which retains a plurality of carriers C (containers), and a plurality of treatment units 100 (12 treatment units 100 in this embodiment) which each treat a wafer W with a treatment liquid. The treatment units 100 are disposed in vertically stacked relation.

The substrate treatment apparatus 1 further includes an indexer robot IR (transport robot) which transports a wafer W between the load port LP and a center robot CR, the center robot CR (transport robot) which transports a wafer W between the indexer robot IR and the treatment units 100, and a computer 55 (control unit) which controls the operations of devices provided in the substrate treatment apparatus 1 and the opening and closing of valves.

As shown in FIG. 1A, the load port LP is horizontally spaced from the treatment units 100. The carriers C, which are each adapted to contain a plurality of wafers W, are arranged in a horizontal arrangement direction D as seen in plan. The indexer robot IR transports the wafers W one by one from the carriers C to the center robot CR, and transports the wafers W one by one from the center robot CR to the carriers C. Similarly, the center robot CR transports the wafers W one by one from the indexer robot IR to the treatment units 100. Further, the center robot CR transports a wafer W between the treatment units 100 as required.

The indexer robot IR includes two hands H each having a U-shape as seen in plan. The two hands H are disposed at different height levels. The hands H each horizontally hold a wafer W. The indexer robot IR moves its hands H horizontally and vertically. The indexer robot IR rotates (turns) about its vertical axis to change the orientations of the hands H. The indexer robot IR is movable in the arrangement direction D along a path extending through a transfer position (a position shown in FIG. 1A). The transfer position is such that the indexer robot IR and the center robot CR are opposed to each other perpendicularly to the arrangement direction D as seen in plan. The indexer robot IR locates its hands H in opposed relation to a desired one of the carriers C or the center robot CR. The indexer robot IR moves its hands H to perform a loading operation to load a wafer W to any of the carriers C and perform an unloading operation to unload a wafer W from any of the carriers C. The indexer robot IR cooperates with the center robot CR to perform a transfer operation at the transfer position to transfer a wafer W from one of the indexer robot IR and the center robot CR to the other robot.

Similarly to the indexer robot IR, the center robot CR includes two hands H each having a U-shape as seen in plan. The two hands H are disposed at different height levels. The hands H each horizontally hold a wafer W. The center robot CR moves its hands H horizontally and vertically. The center robot CR rotates (turns) about its vertical axis to change the orientations of the hands H. The center robot CR is surrounded by the treatment units as seen in plan. The center robot CR locates its hands H in opposed relation to a desired one of the treatment units 100 or the indexer robot IR. The center robot CR moves its hands H to perform a loading operation to load a wafer W to any of the treatment units 100 and perform an unloading operation to unload a wafer W from any of the treatment units 100. The center robot CR cooperates with the indexer robot IR to perform a transfer operation to transfer a wafer W from one of the indexer robot IR and the center robot CR to the other robot.

FIG. 1B is a diagram schematically showing the construction of each of the treatment units 100 which perform a substrate treatment method according to the first embodiment of the present invention.

The treatment units 100 each include a treatment chamber 2 defined by a partition wall (see FIG. 1A), a wafer holding mechanism 3 (substrate holding unit) which holds a wafer W, a lift-off liquid nozzle 4 which supplies an SPM liquid (exemplary resist lift-off liquid) to a front surface (upper surface) of the wafer W held by the wafer holding mechanism 3, and a heater 54 which is located in opposed relation to the front surface of the wafer W held by the wafer holding mechanism 3 to heat the wafer W and a liquid film of the treatment liquid (the SPM liquid or SC1 to be described later) retained on the wafer W. The wafer holding mechanism 3, the lift-off liquid nozzle 4 and the heater 54 are disposed in the treatment chamber 2.

The wafer holding mechanism 3 is, for example, of a clamping type. More specifically, the wafer holding mechanism 3 includes a rotative drive mechanism (substrate rotating unit), a spin shaft 7 integral with a drive shaft of the rotative drive mechanism 6, a disk-shaped spin base 8 generally horizontally attached to an upper end of the spin shaft 7, and a plurality of clamping members 9 provided generally equiangularly circumferentially of the spin base 8. The rotative drive mechanism 6 is, for example, an electric motor. The clamping members 9 generally horizontally clamp the wafer W. When the rotative drive mechanism 6 is driven in this state, the spin base 8 is rotated about a predetermined vertical rotation axis A1 by the driving force of the rotative drive mechanism 6. Thus, the wafer W is rotated about the rotation axis A1 together with the spin base 8 while being generally horizontally held.

The wafer holding mechanism 3 is not limited to the clamping type, but may be, for example, of a vacuum suction type, which sucks a back surface of the wafer W by vacuum to horizontally hold the wafer W and, in this state, is rotated about the rotation axis A1 to rotate the wafer W thus held.

The lift-off liquid nozzle 4 is, for example, a straight nozzle which spouts the SPM liquid in the form of a continuous stream. The lift-off liquid nozzle 4 is attached to a distal end of a generally horizontally extending first liquid arm 11 with its spout directed downward. The first liquid arm 11 is pivotal about a predetermined vertical pivot axis (not shown). A first liquid arm pivot mechanism 12 for pivoting the first liquid arm 11 within a predetermined angular range is connected to the first liquid arm 11. The lift-off liquid nozzle 4 is moved between a position on the rotation axis A1 of the wafer W (at which the lift-off liquid nozzle 4 is opposed to the rotation center of the wafer W) and a home position defined on a lateral side of the wafer holding mechanism 3 by pivoting the first liquid arm 11.

A lift-off liquid supply mechanism 13 (treatment liquid supplying unit) for supplying the SPM liquid to the lift-off liquid nozzle 4 includes a mixing portion 14 for mixing sulfuric acid (H₂SO₄) and hydrogen peroxide solution (H₂O₂), and a lift-off liquid supply line 15 connected between the mixing portion 14 and the lift-off liquid nozzle 4. A sulfuric acid supply line 16 and a hydrogen peroxide solution supply line 17 are connected to the mixing portion 14. Sulfuric acid temperature-controlled at a predetermined temperature (e.g., about 80° C.) is supplied to the sulfuric acid supply line 16 from a sulfuric acid supply portion (not shown) to be described later. On the other hand, a hydrogen peroxide solution not temperature-controlled but having a temperature generally equal to a room temperature (about 25° C.) is supplied to the hydrogen peroxide solution supply line 17 from a hydrogen peroxide solution supply source (not shown).

A sulfuric acid valve 18 and a flow rate control valve 19 are provided in the sulfuric acid supply line 16. Further, a hydrogen peroxide solution valve 20 and a flow rate control valve 21 are provided in the hydrogen peroxide solution supply line 17. In the lift-off liquid supply line 15, an agitation flow pipe 22 and a lift-off liquid vale 23 are provided in this order from the side of the mixing portion 14. The agitation flow pipe 22 is configured such that a plurality of rectangular planar agitation fins each twisted by about 180 degrees about an axis extending in a liquid flowing direction are provided in a tubular member so as to be angularly offset from each other by 90 degrees about a center axis of the tubular member extending in the liquid flowing direction.

When the sulfuric acid valve 18 and the hydrogen peroxide solution valve 20 are opened with the lift-off liquid valve 23 being open, sulfuric acid from the sulfuric acid supply line 16 and the hydrogen peroxide solution from the hydrogen peroxide solution supply line 17 flow into the mixing portion 14, and then flow out of the mixing portion 14 into the lift-off liquid supply line 15. Sulfuric acid and the hydrogen peroxide solution flow through the agitation flow pipe 22 to be thereby sufficiently agitated when flowing through the lift-off liquid supply line 15. With the agitation in the agitation flow pipe 22, sulfuric acid and the hydrogen peroxide solution sufficiently react with each other, whereby an SPM liquid containing a great amount of peroxosulfuric acid (H₂SO₅) is prepared. The temperature of the SPM liquid is increased to a temperature level higher than the liquid temperature of sulfuric acid supplied to the mixing portion 14 by reaction heat generated by the reaction between sulfuric acid and the hydrogen peroxide solution. The SPM liquid having a higher temperature is supplied to the lift-off liquid nozzle 4 through the lift-off liquid supply line 15.

In this embodiment, sulfuric acid is stored in a sulfuric acid tank (not shown) of the sulfuric acid supply portion (not shown). Sulfuric acid stored in the sulfuric acid tank is temperature-controlled at a predetermined temperature (e.g., about 80° C.) by a temperature controller (not shown). Sulfuric acid stored in the sulfuric acid tank is supplied to the sulfuric acid supply line 16. In the mixing portion 14, sulfuric acid having a temperature of about 80° C., for example, is mixed with the hydrogen peroxide solution kept at a room temperature, whereby an SPM liquid having a temperature of about 140° C., for example, is prepared. The SPM liquid having a temperature of about 140° C. is spouted from the lift-off liquid nozzle 4.

The treatment units 100 each further include a DIW nozzle 24 from which DIW (deionized water) is supplied as a rinse liquid onto the front surface of the wafer W held by the wafer holding mechanism 3, and an SC1 nozzle 25 from which SC1 (an ammonia-hydrogen peroxide mixture) is supplied as a cleaning chemical liquid onto the front surface of the wafer W held by the wafer holding mechanism 3.

The DIW nozzle 24 is a straight nozzle which spouts the DIW, for example, in the form of a continuous stream, and is fixedly disposed above the wafer holding mechanism 3 with its spout directed toward around the rotation center of the wafer W. The DIW nozzle 24 is connected to a DIW supply line 26 to which the DIW is supplied from a DIN supply source. A DIW valve 27 for switching on and off the supply of the DIW from the DIW nozzle 24 is provided in the DIW supply line 26.

The SC1 nozzle 25 is a straight nozzle which spouts the SC1, for example, in the form of a continuous stream, and is fixed to a distal end of a generally horizontally extending second liquid arm 28 with its spout directed downward. The second liquid arm 28 is pivotal about a predetermined vertical pivot axis (not shown). A second liquid arm pivot mechanism 29 for pivoting the second liquid arm 28 within a predetermined angular range is connected to the second liquid arm 28. The SC1 nozzle 25 is moved between a center position on the rotation axis A1 of the wafer W (at which the SC1 nozzle 25 is opposed to the rotation center of the wafer W) and a home position defined on a lateral side of the wafer holding mechanism 3 by pivoting the second liquid arm 28.

The SC1 nozzle 25 is connected to an SC1 supply line 30 to which the SC1 is supplied from an SC1 supply source. An SC1 valve 31 for switching on and off the supply of the SC1 from the SC1 nozzle 25 is provided in the SC1 supply line 30.

A vertically extending support shaft 33 is disposed on a lateral side of the wafer holding mechanism 3. A horizontally extending heater arm 34 is connected to an upper end of the support shaft 33, and the heater 54 is attached to a distal end of the heater arm 34. A pivot drive mechanism 36 which rotates the support shaft 33 about its center axis and a lift drive mechanism 37 which moves up and down the support shaft 33 along its center axis are connected to the support shaft 33.

A driving force is inputted to the support shaft 33 from the pivot drive mechanism 36 to rotate the support shaft 33 within a predetermined angular range, whereby the heater arm 34 is pivoted about the support shaft 33 above the wafer W held by the wafer holding mechanism 3. By pivoting the heater arm 34, the heater 54 is moved between a position on the rotation axis A1 of the wafer W (at which the heater 54 is opposed to the rotation center of the wafer W) and a home position defined on a lateral side of the wafer holding mechanism 3. Further, a driving force is inputted to the support shaft 33 from the lift drive mechanism 37 to move up and down the support shaft 33, whereby the heater 54 is moved up and down between a position adjacent to the front surface of the wafer W held by the wafer holding mechanism 3 (a height position indicated by a two-dot-and-dash line in FIG. 1B, and including a middle adjacent position, an edge adjacent position and a center adjacent position to be described later) and a retracted position above the wafer W (a height position indicated by a solid line in FIG. 1B). In this embodiment, the adjacent position is defined so that a lower end face of the heater 54 is spaced a distance of, for example, 3 mm from the front surface of the wafer W held by the wafer holding mechanism 3.

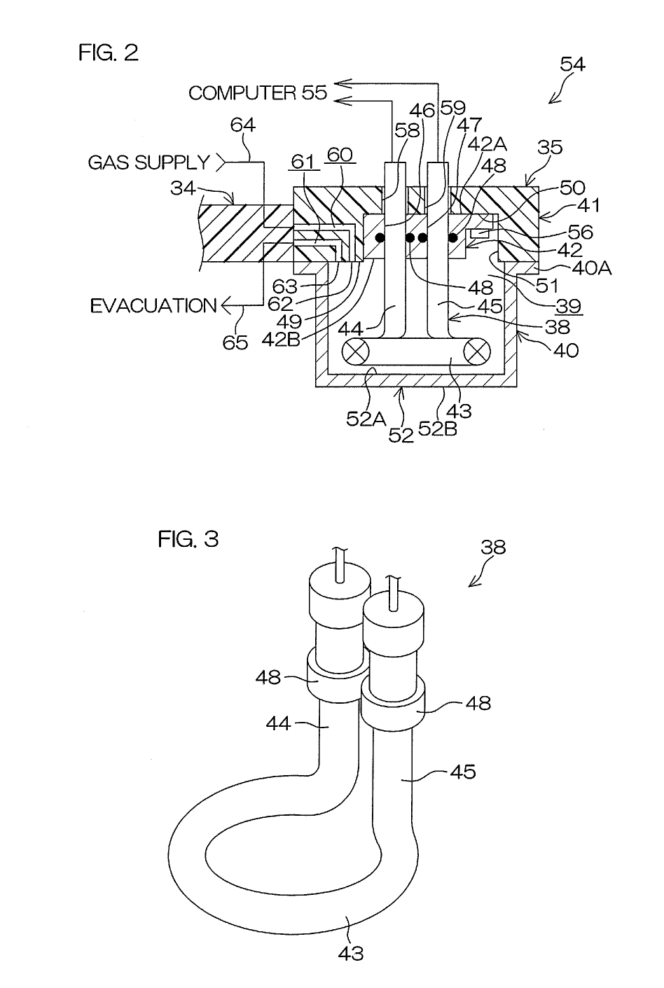

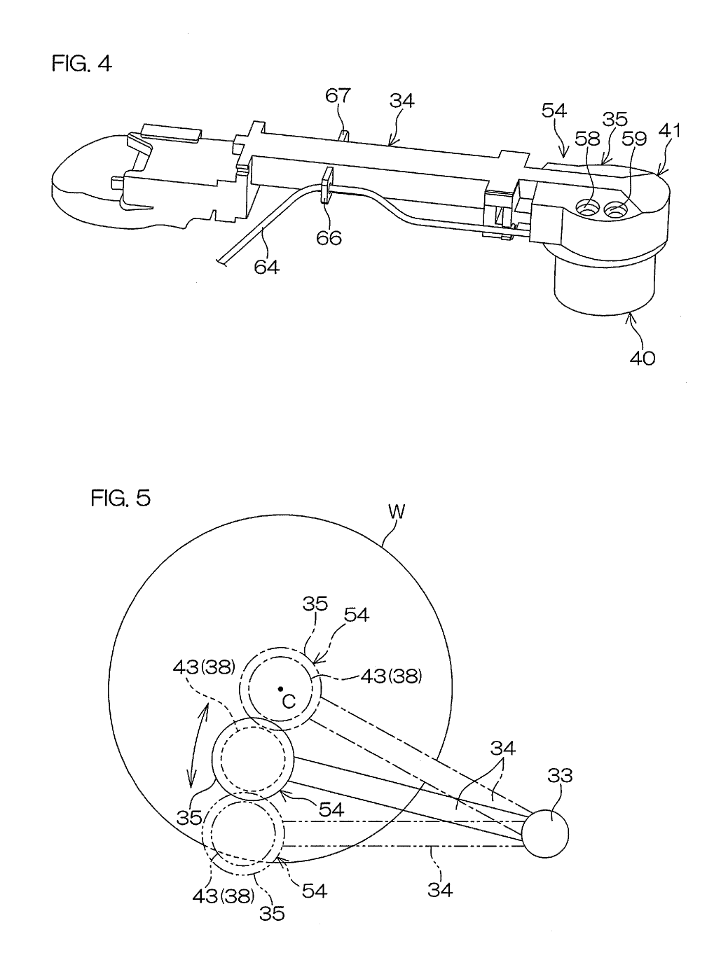

FIG. 2 is a schematic sectional view of the heater 54. FIG. 3 is a perspective view of an infrared lamp 38. FIG. 4 is a perspective view of the heater arm 34 and the heater 54.

As shown in FIG. 2, the heater 54 includes a heater head 35, an infrared lamp 38, a lamp housing 40 which is a bottomed container having a top opening 39 and accommodating the infrared lamp 38, a support member 42 which supports the infrared lamp 38 while suspending the infrared lamp 38 in the lamp housing 40, and a lid 41 which closes the opening 39 of the lamp housing 40. In this embodiment, the lid 41 is fixed to the distal end of the heater arm 34.

As shown in FIGS. 2 and 3, the infrared lamp 38 is a unitary infrared lamp heater which includes an annular portion 43 having an annular shape, and a pair of straight portions 44, 45 extending vertically upward from opposite ends of the annular portion 43 along a center axis of the annular portion 43. The annular portion 43 mainly functions as a light emitting portion which emits infrared radiation. In this embodiment, the annular portion 43 has an outer diameter of, for example, about 60 mm. With the infrared lamp 38 supported by the support member 42, the center axis of the annular portion 43 vertically extends. In other words, the center axis of the annular portion 43 is perpendicular to the front surface of the wafer W held by the wafer holding mechanism 3. The annular portion 43 of the infrared lamp 38 is disposed in a generally horizontal plane.

The infrared lamp 38 includes a quartz tube, and a filament accommodated in the quartz tube. Typical examples of the infrared lamp 38 include infrared heaters of shorter wavelength, intermediate wavelength and longer wavelength such as halogen lamps and carbon lamps. The computer 55 is connected to the infrared lamp 38 for power supply to the infrared lamp 38.

As shown in FIGS. 2 and 4, the lid 41 has a disk shape, and is fixed to the heater arm 34 as extending longitudinally of the heater arm 34. The lid 41 is formed of a fluororesin such as PTFE (polytetrafluoroethylene). In this embodiment, the lid 41 is formed integrally with the heater arm 34. However, the lid 41 may be formed separately from the heater arm 34. Exemplary materials for the lid 41 other than the resin material such as PTFE include ceramic materials and quartz.

As shown in FIG. 2, the lid 41 has a groove 51 (having a generally cylindrical shape) formed in a lower surface 49 thereof. The groove 51 has a horizontal flat upper base surface 50, and an upper surface 42A of the support member 42 is fixed to the upper base surface 50 in contact with the upper base surface 50. As shown in FIGS. 2 and 4, the lid 41 has insertion holes 58, 59 extending vertically through the upper base surface 50 and a lower surface 42B. Upper end portions of the straight portions 44, 45 of the infrared lamp 38 are respectively inserted in the insertion holes 58, 59. In FIG. 4, the heater head 35 is illustrated with the infrared lamp 38 removed therefrom.

As shown in FIG. 2, the lamp housing 40 of the heater head 35 is a bottomed cylindrical container. The lamp housing 40 is formed of quartz.

In the heater head 35, the lamp housing 40 is fixed to the lower surface 49 of the lid 41 (fixed to a portion of the lower surface 49 of the lid 41 not formed with the groove 51 in this embodiment) with its opening 39 facing up. An annular flange 40A projects radially outward (horizontally) from a peripheral edge of the opening of the lamp housing 40. The flange 40A is fixed to the lower surface 49 of the lid 41 with a fixture portion such as bolts (not shown), whereby the lamp housing 40 is supported by the lid 41.

A bottom plate 52 of the lamp housing 40 has a horizontal disk shape. The bottom plate 52 has an upper surface 52A and a lower surface 52B which are horizontal flat surfaces. In the lamp housing 40, a lower portion of the annular portion 43 of the infrared lamp 38 is located in closely opposed relation to the upper surface 52A of the bottom plate 52. The annular portion 43 and the bottom plate 52 are parallel to each other. In other words, the lower portion of the annular portion 43 is covered with the bottom plate 52 of the lamp housing 40. In this embodiment, the lamp housing 40 has an outer diameter of, for example, about 85 mm. Further, a vertical distance between a lower end of the infrared lamp 38 (a lower portion of the annular portion 43) and the upper surface 52A is, for example, about 2 mm.

The support member 42 is a thick plate having a generally disk shape. The support member 42 is horizontally attached and fixed to the lid 41 from below by bolts 56 or the like. The support member 42 is formed of a heat-resistant material (e.g., a ceramic or quartz). The support member 42 has two insertion holes 46, 47 extending vertically through the upper surface 42A and the lower surface 42B thereof. The straight portions 44, 45 of the infrared lamp 38 are respectively inserted in the insertion holes 46, 47.

O-rings are respectively fixedly fitted around intermediate portions of the straight portions 44, 45. With the straight portions 44, 45 respectively inserted in the insertion holes 46, 47, outer peripheries of the O-rings 48 are kept in press contact with inner walls of the corresponding insertion holes 46, 47. Thus, the straight portions 44, 45 are prevented from being withdrawn from the insertion holes 46, 47, whereby the infrared lamp 38 is suspended to be supported by the support member 42.

The emission of the infrared radiation from the heater 54 is controlled by the computer 55 (specifically, a CPU 55A to be described later). More specifically, when the computer 55 controls the heater 54 to supply electric power to the infrared lamp 38, the infrared lamp 38 starts emitting infrared radiation. The infrared radiation emitted from the infrared lamp 38 is outputted through the lamp housing 40 downward of the heater head 35. In a resist removing process to be described later, the bottom plate 52 of the lamp housing 40 which defines the lower end face of the heater head 35 is located in opposed relation to the front surface of the wafer W held by the wafer holding mechanism 3 and, in this state, the infrared radiation outputted through the bottom plate 52 of the lamp housing 40 heats the wafer W and the treatment liquid film (the SPM liquid film or the SC1 liquid film) present on the wafer W. Since the annular portion 43 of the infrared lamp 38 assumes a horizontal attitude, the infrared radiation can be evenly applied onto the front surface of the wafer W horizontally held. Thus, the wafer W and the treatment liquid present on the wafer W can be efficiently irradiated with the infrared radiation.

In the heater head 35, the periphery of the infrared lamp 38 is covered with the lamp housing 40. Further, the flange 40A of the lamp housing 40 and the lower surface 49 of the lid 41 are kept in intimate contact with each other circumferentially of the lamp housing 40. Further, the opening 39 of the lamp housing 40 is closed by the lid 41. Thus, an atmosphere containing droplets of the treatment liquid around the front surface of the wafer W is prevented from entering the lamp housing 40 and adversely influencing the infrared lamp 38 in the resist removing process to be described later. Further, the treatment liquid droplets are prevented from adhering onto the quartz tube wall of the infrared lamp 38, so that the amount of the infrared radiation emitted from the infrared lamp 38 can be stabilized for a longer period of time.

The lid 41 includes a gas supply passage 60 through which air is supplied into the lamp housing 40, and an evacuation passage 61 through which an internal atmosphere of the lamp housing 40 is expelled. The gas supply passage 60 and the evacuation passage 61 respectively have a gas supply port 62 and an evacuation port 63 which are open in the lower surface of the lid 41. The gas supply passage 60 is connected to one of opposite ends of a gas supply pipe 64. The other end of the gas supply pipe 64 is connected to an air supply source. The evacuation passage 61 is connected to one of opposite ends of an evacuation pipe 65. The other end of the evacuation pipe 65 is connected to an evacuation source.

While air is supplied into the lamp housing 40 from the gas supply port 62 through the gas supply pipe 64 and the gas supply passage 60, the internal atmosphere of the lamp housing 40 is expelled to the evacuation pipe 65 through the evacuation port 63 and the evacuation passage 61. Thus, a higher-temperature atmosphere in the lamp housing 40 can be expelled for ventilation. Thus, the inside of the lamp housing 40 can be cooled. As a result, the infrared lamp 38 and the lamp housing 40, particularly the support member 42, can be advantageously cooled.

As shown in FIG. 4, the gas supply pipe 64 and the evacuation pipe 65 (not shown in FIG. 4, but see FIG. 2) are respectively supported by a gas supply pipe holder 66 provided on the heater arm 34 and an evacuation pipe holder 67 provided on the heater arm 34.

FIG. 5 is a plan view showing positions of the heater 54.

The pivot drive mechanism 36 and the lift drive mechanism 37 are controlled to move the heater 54 along an arcuate path crossing a wafer rotating direction above the front surface of the wafer W.

When the wafer W and the SPM liquid or the SC1 present on the wafer W are heated by the heater 54, the heater 54 is located at the adjacent position at which the bottom plate 52 (lower end face) of the heater head 35 is opposed to and spaced a minute distance (e.g., 3 mm) from the front surface of the wafer W. During the heating, the bottom plate 52 (lower surface 52B) and the front surface of the wafer W are kept spaced the minute distance from each other.

Examples of the adjacent position of the heater 54 include a middle adjacent position (indicated by a solid line in FIG. 5), an edge adjacent position (indicated by a two-dot-and-dash line in FIG. 5) and a center adjacent position (indicated by a one-dot-and-dash line in FIG. 5).

With the heater 54 located at the middle adjacent position, the center of the round heater 54 as seen in plan is opposed to a radially intermediate portion of the front surface of the wafer W (a portion intermediate between the rotation center (on the rotation axis A1) and a peripheral edge portion of the wafer W), and the bottom plate 52 of the heater head 35 is spaced the minute distance (e.g., 3 mm) from the front surface of the wafer W.

With the heater 54 located at the edge adjacent position, the center of the round heater 54 as seen in plan is opposed to the peripheral edge portion of the front surface of the wafer W, and the bottom plate 52 of the heater head 35 is spaced the minute distance (e.g., 3 mm) from the front surface of the wafer W.

With the heater 54 located at the center adjacent position, the center of the round heater 54 as seen in plan is opposed to the rotation center (on the rotation axis A1) of the front surface of the wafer W, and the bottom plate 52 of the heater head 35 is spaced the minute distance (e.g., 3 mm) from the front surface of the wafer W.

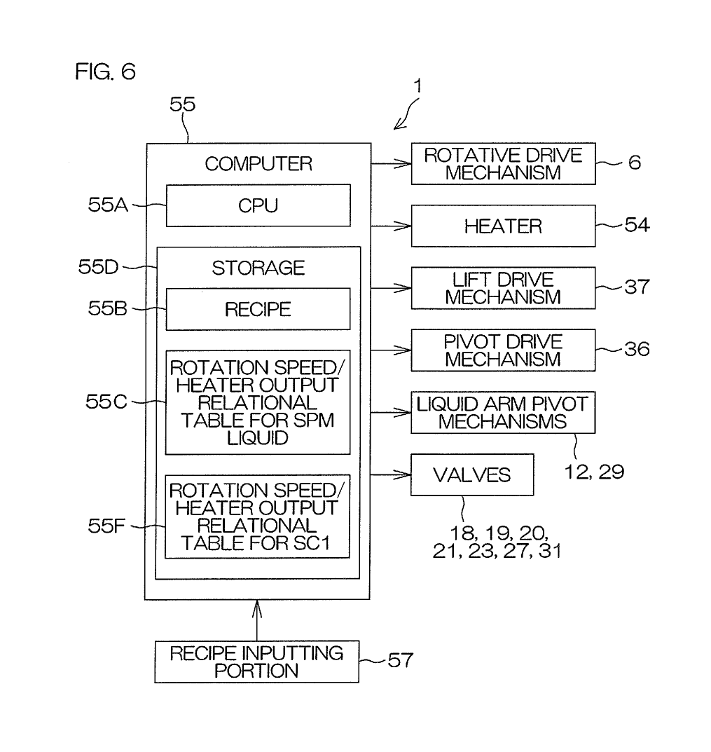

FIG. 6 is a block diagram showing the electrical construction of the substrate treatment apparatus 1.

The substrate treatment apparatus 1 includes the computer 55. The computer 55 includes the CPU 55A, and a storage 55D (recipe storing unit). The storage 55D stores a recipe 55B, a rotation speed/heater output relational table 55C for the SPM liquid, and a rotation speed/heater output relational table 55F for the SC1.

Exemplary data stored in the storage 55D include data for a process recipe (recipe 55B) which specifies treatments to be performed on the wafer W (procedures, conditions and the like), and relational tables indicating relationships between the rotation speed of the wafer W and the output of the heater 54 (the rotation speed/heater output relational table 55C for the SPM liquid and the rotation speed/heater output relational table 55F for the SC1).

The rotation speed/heater output relational table 55C for the SPM liquid specifies a relationship between the rotation speed of the wafer W and the output of the heater 54 such that, during the supply of the SPM liquid, the output of the heater 54 is reduced as the rotation speed of the wafer W increases. More specifically, the rotation speed/heater output relational table 55C for the SPM liquid specifies a relationship between the rotation speed of the wafer W and the output of the heater 54 such that sufficient heat can reach a portion of the SPM liquid film present around an interface between the front surface of the wafer W and the SPM liquid film without damaging the front surface of the wafer W. The thickness of the liquid film of the SPM liquid supplied to the front surface of the wafer W is dependent on the rotation speed of the wafer W. The higher the rotation speed of the wafer W, the smaller the thickness of the SPM liquid film. The lower the rotation speed of the wafer W, the greater the thickness of the SPM liquid film. Where the relationship between the rotation speed of the wafer W and the output of the heater 54 is specified by the rotation speed/heater output relational table 55C for the SPM liquid, therefore, sufficient heat can reach the SPM liquid portion present around the interface between the front surface of the wafer W and the SPM liquid film without damaging the front surface of the wafer W.

Similarly, the rotation speed/heater output relational table 55F for the SC1 specifies a relationship between the rotation speed of the wafer W and the output of the heater 54 such that, during the supply of the SC1, the output of the heater 54 is reduced as the rotation speed of the wafer W increases. More specifically, the rotation speed/heater output relational table 55F for the SC1 specifies a relationship between the rotation speed of the wafer W and the output of the heater 54 such that sufficient heat can reach a portion of the SC1 liquid film present around an interface between the front surface of the wafer W and the SC1 liquid film without damaging the front surface of the wafer W. The thickness of the liquid film of the SC1 supplied to the front surface of the wafer W is dependent on the rotation speed of the wafer W. The higher the rotation speed of the wafer W, the smaller the thickness of the SC1 liquid film. The lower the rotation speed of the wafer W, the greater the thickness of the SC1 liquid film. Where the relationship between the rotation speed of the wafer W and the output of the heater 54 is specified by the rotation speed/heater output relational table 55F for the SC1, therefore, sufficient heat can reach the SC1 liquid film portion present around the interface between the front surface of the wafer W and the SC1 liquid film without damaging the front surface of the wafer W.

The computer 55 is connected to the rotative drive mechanism 6, the heater 54, the pivot drive mechanism 36, the lift drive mechanism 37, the first liquid arm pivot mechanism 12, the second liquid arm pivot mechanism 29, the sulfuric acid valve 18, the hydrogen peroxide solution valve 20, the lift-off liquid valve 23, the DIW valve 27, the SC1 valve 31, the flow rate control valves 19, 21, and the like, which are controlled by the computer 55.

A recipe inputting portion 57 includes a keyboard, a touch panel and other input interfaces which are operated by a user. The user can read the data out of the storage 55D by operating the recipe operating portion 57. Further, the user can make a recipe by using the recipe inputting portion 57 and store the recipe as a recipe 55B in the storage 55D.

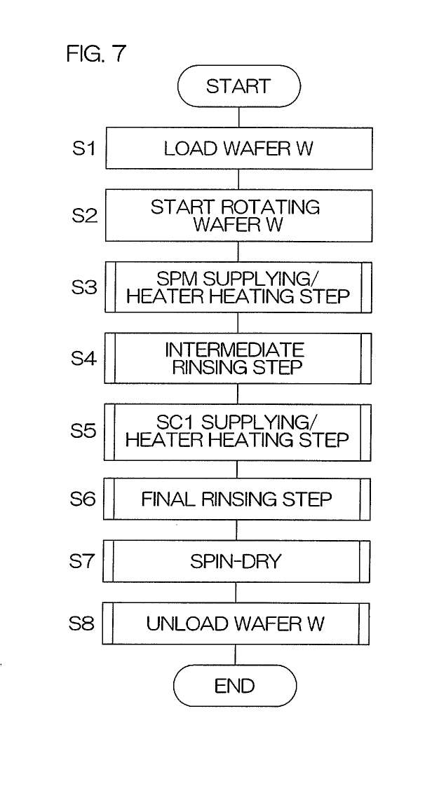

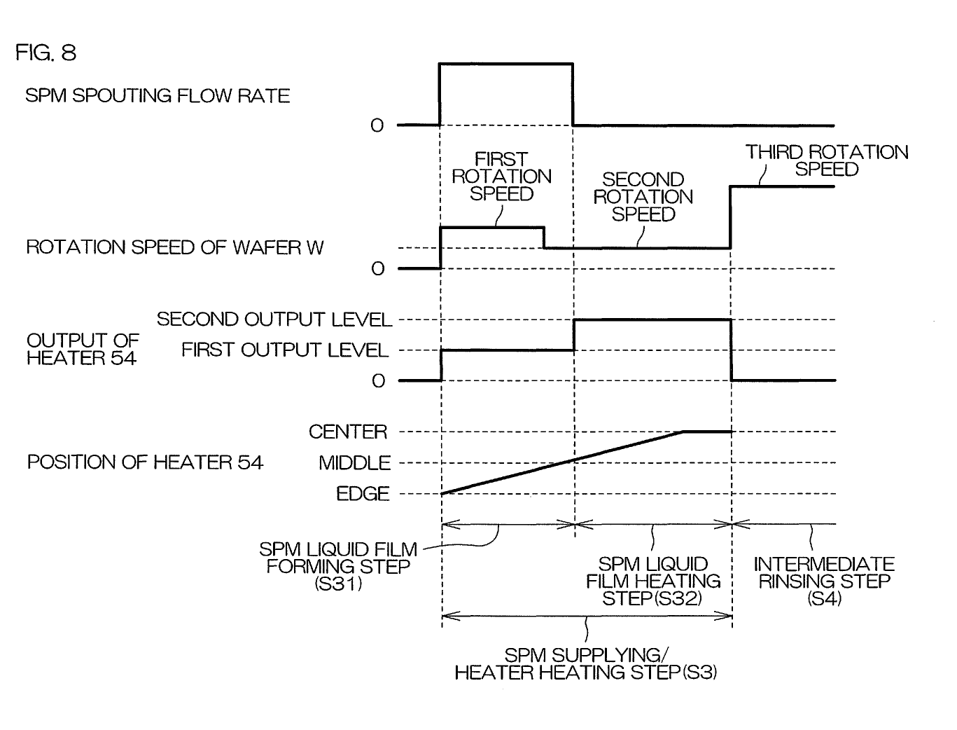

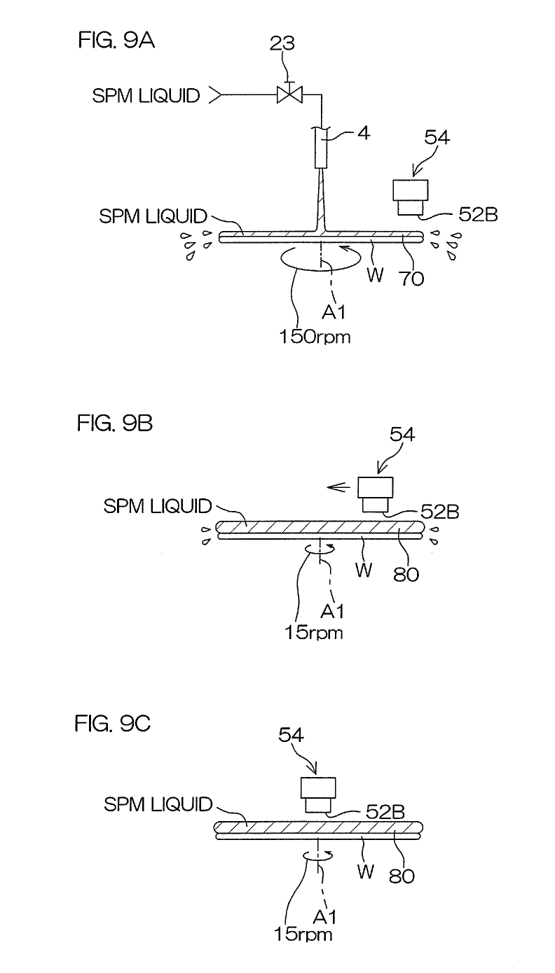

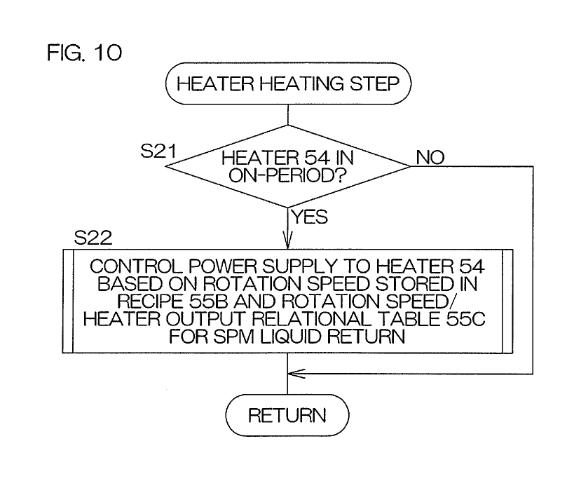

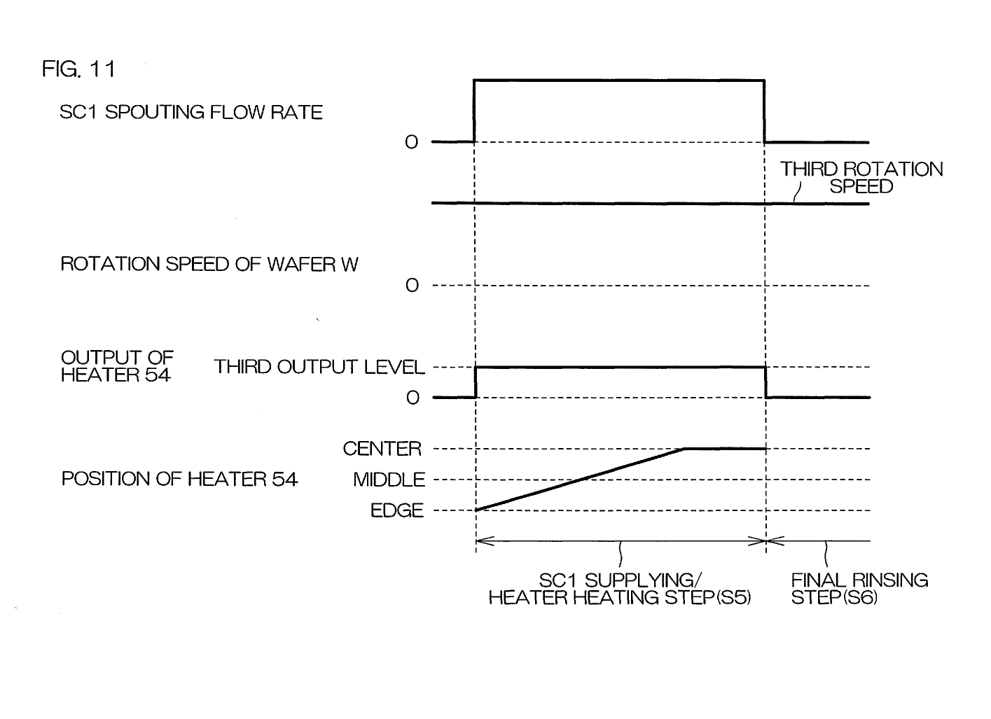

FIG. 7 is a flow chart showing a first exemplary resist removing process according to the first embodiment of the present invention. FIG. 8 is a time chart for explaining a control operation to be performed by the CPU 55A mainly in an SPM liquid film forming step and an SPM liquid film heating step to be described later. FIGS. 9A to 9C are schematic diagrams for explaining the SPM liquid film forming step and the SPM liquid film heating step. FIG. 10 is a flow chart showing a control operation to be performed for the power supply to the heater 54. FIG. 11 is a time chart for explaining an SC1 supplying/heater heating step of the first exemplary process.

Referring to FIGS. 1A and 1B and FIGS. 6 to 11, the first exemplary resist removing process will hereinafter be described.

Prior to the resist removing process, the user operates the recipe inputting portion 57 to determine the recipe 55B to specify conditions for the treatment of the wafer W. Subsequently, the CPU 55A performs a process sequence for the treatment of the wafer W based on the recipe 55B.

The CPU 55A controls the indexer robot IR (see FIG. 1A) and the center robot CR (see FIG. 1A) to load a wafer W subjected to the ion implantation process into a treatment chamber 2 (Step S1: Wafer loading step). The wafer W is not subjected to the resist ashing process. The wafer W is transferred to the wafer holding mechanism 3 with its front surface facing up. At this time, the heater 54, the lift-off liquid nozzle 4 and the SC1 nozzle 25 are respectively located at their home positions so as not to prevent the loading of the wafer W.

With the wafer W held by the wafer holding mechanism 3, the CPU 55A controls the rotative drive mechanism 6 to start rotating the wafer W (Step S2). The rotation speed of the wafer W is increased to a predetermined first rotation speed, and then maintained at the first rotation speed. The first rotation speed is such that the entire front surface of the wafer W can be covered with the SPM liquid, and may be, for example, 150 rpm. The CPU 55A controls the first liquid arm pivot mechanism 12 to move the lift-off liquid nozzle 4 to above the wafer W and locate the lift-off liquid nozzle 4 above the rotation center of the wafer W (on the rotation axis A1). Further, the CPU 55A opens the sulfuric acid valve 18, the hydrogen peroxide solution valve 20 and the lift-off liquid valve 23 to spout the SPM liquid from the lift-off liquid nozzle 4. The SPM liquid spouted from the lift-off liquid nozzle 4 is supplied to the front surface of the wafer W as shown in FIGS. 8 and 9A (Step S31: SPM liquid film forming step).

The SPM liquid supplied to the front surface of the wafer W spreads from a center portion of the front surface of the wafer W to a peripheral portion of the front surface of the wafer W by a centrifugal force generated by the rotation of the wafer W. Thus, the SPM liquid spreads over the entire front surface of the wafer W to form a liquid film 70 of the SPM liquid which covers the entire front surface of the wafer W. The SPM liquid film 70 has a thickness of, for example, 0.4 mm.

The CPU 55A controls the pivot drive mechanism 36 and the lift drive mechanism 37 to move the heater 54 to above the edge adjacent position (indicated by the two-dot-and-dash line in FIG. 5) from the home position defined on the lateral side of the wafer holding mechanism 3 and then down to the edge adjacent position, and further move the heater 54 at a constant speed toward the center adjacent position (indicated by the one-dot-and-dash line in FIG. 5).

The SPM liquid film forming step of Step S31 and an SPM liquid film heating step of Step S32 to be described below are collectively referred to as an SPM supplying/heater heating step (Step S3). Throughout the SPM supplying/heater heating step of Step S3, the heater 54 emits infrared radiation, and the output of the heater 54 is determined so as to be adapted for the rotation speed of the wafer W.

In the SPM liquid film forming step of Step S31, as shown in FIG. 10, the CPU 55A judges if the heater 54 is currently in an ON period, with reference to a timer (not shown) for monitoring the progression status of the resist removing process (Step S21).

If the heater 54 is in the ON period (YES in Step S21), the CPU 55A determines the level of electric power to be supplied to the heater 54 based on the rotation speed of the wafer W stored in the recipe 55B and the rotation speed/heater output relational table 55C for the SPM liquid (Step S22). Then, the electric power is supplied at the level thus determined to the heater 54. The SPM liquid film present on the front surface of the wafer W is heated to a higher temperature by the infrared radiation emitted from the heater 54. Thus, even a resist having a hardened surface layer can be removed from the front surface of the wafer W without ashing thereof.

If the heater 54 is not in the ON period (NO in Step S21), on the other hand, the electric power is not supplied to the heater 54. Thus, the output of the heater 54 is controlled to an output level suitable for the rotation speed of the wafer W stored in the recipe 55B. At this time, the rotation speed of the wafer W is a relatively high first rotation speed in the SPM liquid film forming step of Step S31, so that a relatively thin SPM liquid film is formed on the front surface of the wafer W. Therefore, the CPU 55A controls the output of the heater 54 to a relatively low first output level (e.g., about 40% of the maximum output level) based on the relationship between the rotation speed of the wafer W and the output of the heater 54 specified by the rotation speed/heater output relational table 55C for the SPM liquid (see FIG. 6).

The first output level is such that sufficient heat can reach a portion of the SPM liquid film 70 present around the interface between the front surface of the wafer W and the SPM liquid film without damaging the front surface of the wafer W. This prevents the overheating of the front surface of the wafer W and the insufficient heating of the SPM liquid film 70. As a result, the resist can be efficiently lifted off from the front surface of the wafer W without damaging the front surface of the wafer W in the SPM liquid film forming step of Step S31.

After a lapse of a predetermined SPM liquid supply period from the start of the supply of the SPM liquid, the CPU 55A controls the rotative drive mechanism 6 to reduce the rotation speed of the wafer W from the first rotation speed to a second rotation speed. The second rotation speed is, for example, such that an SPM liquid film 80 thicker than the SPM liquid film 70 can be retained on the front surface of the wafer W (a speed in a range of 1 rpm to 30 rpm, e.g., 15 rpm). The thickness of the SPM liquid film 80 is, for example, 1.0 mm.

After a lapse of another predetermined SPM liquid supply period from the start of the supply of the SPM liquid, the CPU 55A closes the sulfuric acid valve 18, the hydrogen peroxide solution valve 20 and the lift-off liquid valve 23 to stop supplying the SPM liquid from the lift-off liquid nozzle 4 as shown in FIGS. 8 and 9B. Further, the CPU 55A controls the first liquid arm pivot mechanism 12 to move the lift-off liquid nozzle 4 back to its home position after the stop of the supply of the SPM liquid. The SPM liquid supply periods should be each longer than a period required for forming the SPM liquid film 70, 80 to cover the entire front surface of the wafer W. The SPM liquid supply periods vary depending on the spouting flow rate of the SPM liquid spouted from the lift-off liquid nozzle 4 and the rotation speed (first rotation speed) of the wafer W, but may be in a range of 3 seconds to 30 seconds, e.g., 15 seconds.

The CPU 55A continues the emission of the infrared radiation from the heater 54 (Step S32: SPM liquid film heating step).

In the SPM liquid film heating step of Step S32, the output level of the heater 54 is determined based on the rotation speed of the wafer W. As in the SPM liquid film forming step of Step S31, more specifically, the CPU 55A determines the level of the electric power to be supplied to the heater 54 based on the rotation speed of the wafer W stored in the recipe 55B and the rotation speed/heater output relational table 55C for the SPM liquid (Step S22 in FIG. 10) in the ON period of the heater 54 (YES in Step S21 in FIG. 10). Then, the electric power is supplied at the output level thus determined to the heater 54. As described above, the rotation speed/heater output relational table 55C for the SPM liquid (see FIG. 6) is defined such that the output of the heater 54 is reduced as the rotation speed of the wafer W increases. Therefore, the output of the heater 54 is controlled to a second output level (e.g., about 95% of the maximum output level) that is higher than the first output level.

The second output level is such that sufficient heat can reach a portion of the SPM liquid film 80 present around the interface between the front surface of the wafer W and the SPM liquid film without damaging the front surface of the wafer W. This prevents the overheating of the front surface of the wafer W and the insufficient heating of the SPM liquid film 80. Therefore, the resist can be efficiently lifted off from the front surface of the wafer W without damaging the front surface of the wafer W in the SPM liquid film heating step of Step S32.

Immediately after the start of the SPM liquid film heating step of Step S32, the heater 54 is located around the middle adjacent position (indicated by the solid line in FIG. 5) in this embodiment. The CPU 55A continuously controls the pivot drive mechanism 36 to move the heater 54 at the predetermined moving speed from the middle adjacent position toward the center adjacent position (indicated by the one-dot-and-dash line in FIG. 5).

After the heater 54 reaches the center adjacent position, the heating of the wafer W is continued at the center adjacent position for a predetermined period. In the SPM liquid film heating step of Step S32, a portion of the wafer W opposed to the bottom plate 52 of the heater head 35 and a portion of the SPM liquid film 80 present on that portion of the wafer W are heated by the infrared radiation emitted from the heater 54. The SPM liquid film heating step of Step S32 is performed for a predetermined heating period (in a range of 2 second to 90 seconds, e.g., about 40 seconds).

After a lapse of a predetermined period from the start of the emission of the infrared radiation from the heater 54, the CPU 55A controls the heater 54 to stop the emission of the infrared radiation. Further, the CPU 55A controls the pivot drive mechanism 36 and the lift drive mechanism 37 to move the heater 54 back to its home position.

Then, the CPU 55A controls the rotative drive mechanism 6 to increase the rotation speed of the wafer W to a predetermined third rotation speed (in a range of 300 rpm to 1500 rpm, e.g., 1000 rpm), and opens the DIW valve 27 to supply the DIW from the spout of the DIW nozzle 24 toward around the rotation center of the wafer W (Step S4: Intermediate rinsing step).

The DIW supplied onto the front surface of the wafer W receives a centrifugal force generated by the rotation of the wafer W to flow toward the peripheral edge of the wafer W on the front surface of the wafer W. Thus, SPM liquid adhering to the front surface of the wafer W is rinsed away with the DIW. After the supply of the DIW is continued for a predetermined period, the CPU 55A closes the DIW valve 27 to stop supplying the DIW to the front surface of the wafer W.

While maintaining the rotation speed of the wafer W at the third rotation speed as shown in FIG. 11, the CPU 55A opens the SC1 valve 31 to supply the SC1 from the SC1 nozzle 25 to the front surface of the wafer W (Step S5: SC1 supplying/heater heating step). The CPU 55A controls the second liquid arm pivot mechanism 29 to pivot the second liquid arm 28 within the predetermined angular range to reciprocally move the SC1 nozzle 25 between a position above the rotation center of the wafer W and a position above the peripheral edge of the wafer W. Thus, an SC1 supply position on the front surface of the wafer W to which the SC1 is supplied from the SC1 nozzle 25 is reciprocally moved along an arcuate path crossing the wafer rotating direction in a range from the rotation center of the wafer W to the peripheral edge of the wafer W. Thus, the SC1 spreads over the entire front surface of the wafer W, whereby a thin liquid film of the SC1 is formed as covering the entire front surface of the wafer W.

The front surface of the wafer W and the SC1 liquid film are warmed by the heater 54 during the supply of the SC1 to the wafer W. More specifically, the CPU 55A controls the heater 54 to start emitting the infrared radiation, and controls the pivot drive mechanism 36 and the lift drive mechanism 37 to move the heater 54 from the home position defined on the lateral side of the wafer holding mechanism 3 to above the edge adjacent position (indicated by the two-dot-and-dash line in FIG. 5) and then down to the edge adjacent position, and move the heater 54 toward the center adjacent position (indicated by the one-dot-and-dash line in FIG. 5) at a constant speed.

In the SC1 supplying/heater heating step of Step S5, the output level of the heater 54 is determined based on the rotation speed of the wafer W. As in the SPM supplying/heater heating step of Step S3, more specifically, the CPU 55A determines the level of the electric power to be supplied to the heater 54 based on the rotation speed of the wafer W stored in the recipe 55B and the rotation speed/heater output relational table 55F for the SC1 (see Step S22 in FIG. 10) in the ON period of the heater 54. Then, the electric power is supplied at the output level thus determined to the heater 54. In the SC1 supplying/heater heating step of Step S5, the rotation speed of the wafer W is the relatively high third rotation speed, so that the output of the heater 54 is controlled to a relatively low third output level suitable for the third rotation speed. The third output level is such that sufficient heat can reach the SC1 liquid film portion present around the interface between the front surface of the wafer W and the SC1 liquid film without damaging the front surface of the wafer W in the SC1 supplying/heater heating step of Step S5.

In the SC1 supplying/heater heating step of Step S5, the method of scanning the SC1 nozzle 25 and the heater 54 is determined so as to prevent the SC1 nozzle 25 and the heater 54 from interfering with each other.

In the SC1 supplying/heater heating step of Step S5, the SC1 is evenly supplied to the entire front surface of the wafer W, whereby particles adhering to the front surface of the wafer W can be efficiently removed for cleaning the front surface of the wafer W. The SC1 is heated by the heater 54 and, therefore, is highly activated. As a result, the cleaning efficiency can be significantly improved.

In the SC1 supplying/heater heating step of Step S5, the output of the heater 54 is controlled to the third output level, thereby preventing the overheating of the front surface of the wafer W and the insufficient heating of the SC1 liquid film. As a result, the front surface of the wafer W can be cleaned without any damage thereto in the SC1 supplying/heater heating step of Step S5.

In this embodiment, the rotation speed of the wafer W is not changed in the SC1 supplying/heater heating step of Step S5. Therefore, the output of the heater 54 is not changed in the SC1 supplying/heater heating step. Where the rotation speed of the wafer W is changed in the SC1 supplying/heater heating step, however, the output of the heater 54 is changed according to the change in the rotation speed.

After the heating by the heater 54 is continued for a predetermined period, the CPU 55A controls the heater 54 to stop the emission of the infrared radiation, and controls the pivot drive mechanism 36 and the lift drive mechanism 37 to move the heater 54 back to its home position.

After the supply of the SC1 is continued for the predetermined period, the CPU 55A closes the SC1 valve 31, and controls the second liquid arm pivot mechanism 29 to move the SC1 nozzle 25 back to its home position. While maintaining the rotation speed of the wafer W at the third rotation speed, the CPU 55A opens the DIW valve 27 to supply the DIW from the spout of the DIW nozzle 24 toward around the rotation center of the wafer W (Step S6: final rinsing step).

The DIW supplied to the front surface of the wafer W receives a centrifugal force generated by the rotation of the wafer W to flow toward the peripheral edge of the wafer W on the front surface of the wafer W, whereby SC1 adhering to the front surface of the wafer W is rinsed away with the DIW.

After a lapse of a predetermined period from the start of the final rinsing step, the CPU 55A closes the DIW valve 27 to stop supplying the DIW to the front surface of the wafer W. Thereafter, the CPU 55A drives the rotative drive mechanism 6 to increase the rotation speed of the wafer W to a predetermined higher rotation speed (e.g., 1500 to 2500 rpm), whereby a spin drying process is performed to spin off the DIW from the wafer W for drying the wafer W (Step S7).

In the spin drying process of Step S7, DIW adhering to the wafer W is removed from the wafer W. It is noted that the rinse liquid to be used in the intermediate rinsing step of Step S4 and the final rinsing step of Step S6 is not limited to the DIW, but other examples of the rinse liquid include carbonated water, electrolytic ion water, ozone water, reduced water (hydrogen water) and magnetic water.

After the spin drying process is performed for a predetermined period, the CPU 55A controls the rotative drive mechanism 6 to stop rotating the wafer holding mechanism 3. Thus, the resist removing process for the single wafer W ends, and the treated wafer W is unloaded from the treatment chamber 2 by the center robot CR (Step S8).

According to this embodiment, as described above, the output of the heater 54 is adjusted according to the rotation speed of the wafer W in the SPM liquid film forming step of Step S31, the SPM liquid film heating step of Step S32 and the SC1 supplying/heater heating step of Step S5. Therefore, the output of the heater 54 can be adapted for the thickness of the liquid film of the treatment liquid (the SPM liquid or the SC1) present on the front surface of the wafer W. Even if the thickness of the liquid film of the treatment liquid (the SPM liquid or the SC1) varies due to a change in the rotation speed of the wafer W, the overheating of the front surface of the wafer W and the insufficient heating of the treatment liquid (the SPM liquid or the SC1) can be prevented. As a result, the front surface of the wafer W can be advantageously treated without any damage thereto.

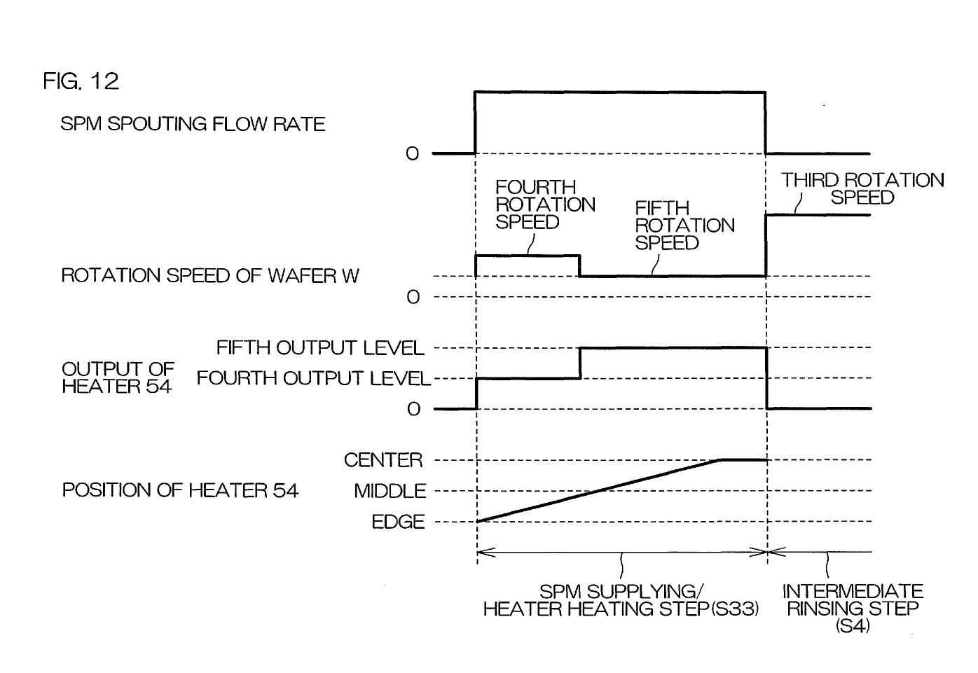

FIG. 12 is a time chart showing a second exemplary resist removing process according to the first embodiment of the present invention. The second exemplary process differs from the first exemplary process in that an SPM supplying/heater heating step of Step S33 shown in FIG. 12 is performed instead of the SPM supplying/heater heating step of Step S3 shown in FIG. 8. Other process steps are performed in the same manner as in the first exemplary process. Therefore, only the SPM supplying/heater heating step of Step S33 in the second exemplary process will be described.

In the SPM supplying/heater heating step of Step S33, the SPM liquid is supplied from the lift-off liquid nozzle 4 to the front surface of the wafer W to cover the front surface of the wafer W with a liquid film of the SPM liquid, and the infrared radiation is emitted from the heater 54 as in the SPM supplying/heater heating step of Step S3 of the first exemplary process. However, the supply of the SPM liquid is continued throughout the period of the emission of the infrared radiation. This differentiates the SPM supplying/heater heating step of Step S33 from the SPM supplying/heater heating step of Step S3 shown in FIG. 8.

In the SPM supplying/heater heating step of Step S33, the wafer W is rotated at a relatively high rotation speed (fourth rotation speed) for a predetermined period (for example, corresponding to the SPM liquid supply period in the first exemplary process), and then rotated at a relatively low fifth rotation speed lower than the fourth rotation speed for a predetermined period (for example, corresponding to the heating period in the first exemplary process) as in the SPM supplying/heater heating step of Step S3. The fourth rotation speed is such that the entire front surface of the wafer W can be covered with the SPM liquid, and may be, for example, 150 rpm which is equal to the first rotation speed described above.

In the second exemplary process, when the rotation speed of the wafer W is the relatively high fourth rotation speed, the output of the heater 54 is controlled to a relatively low fourth output level. When the wafer W is rotated at the relatively high fourth rotation speed, a relatively thin SPM liquid film is formed on the front surface of the wafer W. However, the fourth output level of the heater 54 is such that sufficient heat can reach a portion of the SPM liquid film present around the interface between the front surface of the wafer W and the SPM liquid film without damaging the front surface of the wafer W.

When the rotation speed of the wafer W is the relatively low fifth rotation speed (e.g., not lower than 15 rpm), the output of the heater 54 is controlled to a fifth output level that is higher than the fourth output level. When the rotation speed of the wafer W is changed to the relatively low fifth rotation speed, the thickness of the SPM liquid film is increased. The fifth output level of the heater 54 is such that sufficient heat can reach a portion of the SPM liquid film present around the interface between the front surface of the wafer W and the SPM liquid film without damaging the front surface of the wafer W.

The fifth rotation speed is lower than the fourth rotation speed and higher than the second rotation speed of the first exemplary process described above. Thus, a thicker SPM liquid film is formed on the front surface of the wafer W than when the wafer W is rotated at the fourth rotation speed. The fifth rotation speed is required to be, for example, such that the SPM liquid film can be retained on the front surface of the wafer W.

Thus, the second exemplary process employing the SPM supplying/heater heating step of Step S33 provides effects comparable to those of the first exemplary process described above.

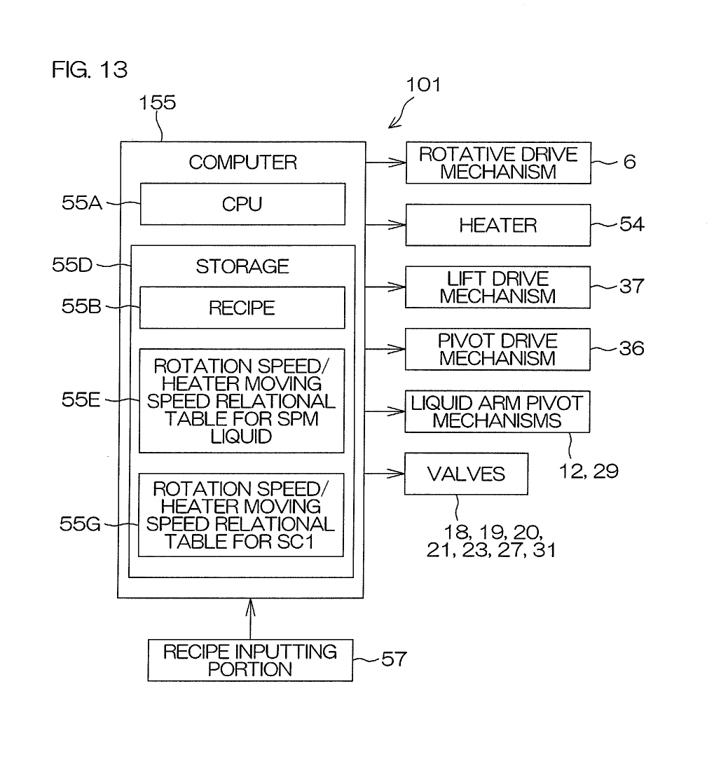

FIG. 13 is a block diagram showing the electrical construction of a substrate treatment apparatus 101 according to a second embodiment of the present invention. A computer 155 of the second embodiment differs from the computer 55 of the first embodiment in that a rotation speed/heater moving speed relational table 55E for the SPM liquid is employed instead of the rotation speed/heater output relational table 55C for the SPM liquid, and a rotation speed/heater moving speed relational table 55G for the SC1 is employed instead of the rotation speed/heater output relational table 55F for the SC1. The other arrangement is the same as the treatment unit 100 of the first embodiment. In FIG. 13, components corresponding to those of the first embodiment shown in FIG. 6 will be designated by the same reference characters as in FIG. 6, and duplicate description will be omitted.

The rotation speed/heater moving speed relational table 55E for the SPM liquid specifies a relationship between the rotation speed of the wafer W and the moving speed of the heater 54 (more specifically, the pivoting speed of the heater arm 34) such that the moving speed of the heater 54 is reduced as the rotation speed of the wafer W decreases. That is, the rotation speed/heater moving speed relational table 55E for the SPM liquid specifies a relationship between the rotation speed of the wafer W and the moving speed of the heater 54 such that sufficient heat can reach a portion of the SPM liquid present around the interface between the front surface of the wafer W and the SPM liquid film without damaging the front surface of the wafer W.

The thickness of the liquid film of the SPM liquid supplied to the front surface of the wafer W is dependent on the rotation speed of the wafer W. Therefore, the higher the rotation speed of the wafer W, the thinner the SPM liquid film. The lower the rotation speed of the wafer W, the thicker the SPM liquid film. If the output of the heater 54 is kept constant, the amount of the heat applied to a predetermined portion of the SPM liquid film varies depending on the rotation speed of the wafer W.

That is, the amount of the heat applied to the predetermined portion of the liquid film is relatively reduced by increasing the moving speed of the heater 54. On the other hand, the amount of the heat applied to the predetermined portion of the liquid film is relatively increased by reducing the moving speed of the heater 54. Where the rotation speed of the wafer W and the moving speed of the heater 54 have a relationship specified by the rotation speed/heater moving speed relational table 55E for the SPM liquid, sufficient heat can reach the SPM liquid film portion present around the interface between the front surface of the wafer W and the SPM liquid film without damaging the front surface of the wafer W.

The rotation speed/heater moving speed relational table 55G for the SC1 specifies a relationship between the rotation speed of the wafer W and the moving speed of the heater 54 (more specifically, the pivoting speed of the heater arm 34) such that the moving speed of the heater 54 is reduced as the rotation speed of the wafer W decreases. That is, the rotation speed/heater moving speed relational table 55G for the SC1 specifies a relationship between the rotation speed of the wafer W and the moving speed of the heater 54 such that sufficient heat can reach a portion of the SC1 liquid film present around the interface between the front surface of the wafer W and the SC1 liquid film without damaging the front surface of the wafer W. Therefore, sufficient heat can reach the SC1 liquid film portion present around the interface between the front surface of the wafer W and the SC1 liquid film without damaging the front surface of the wafer W.

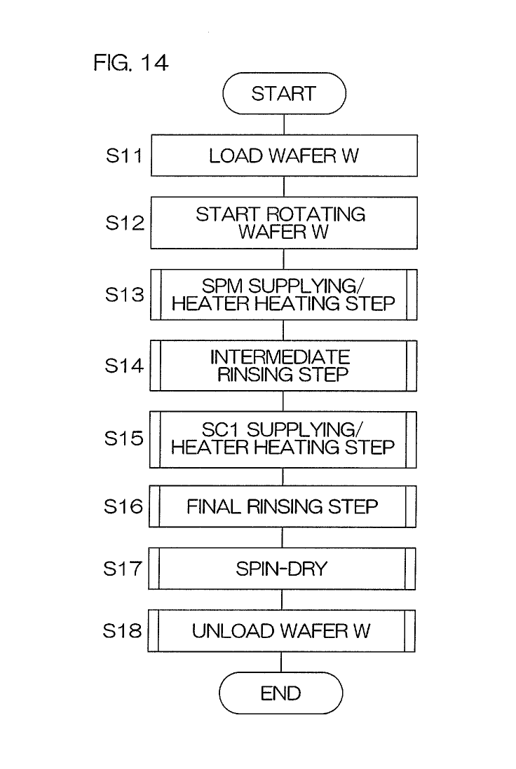

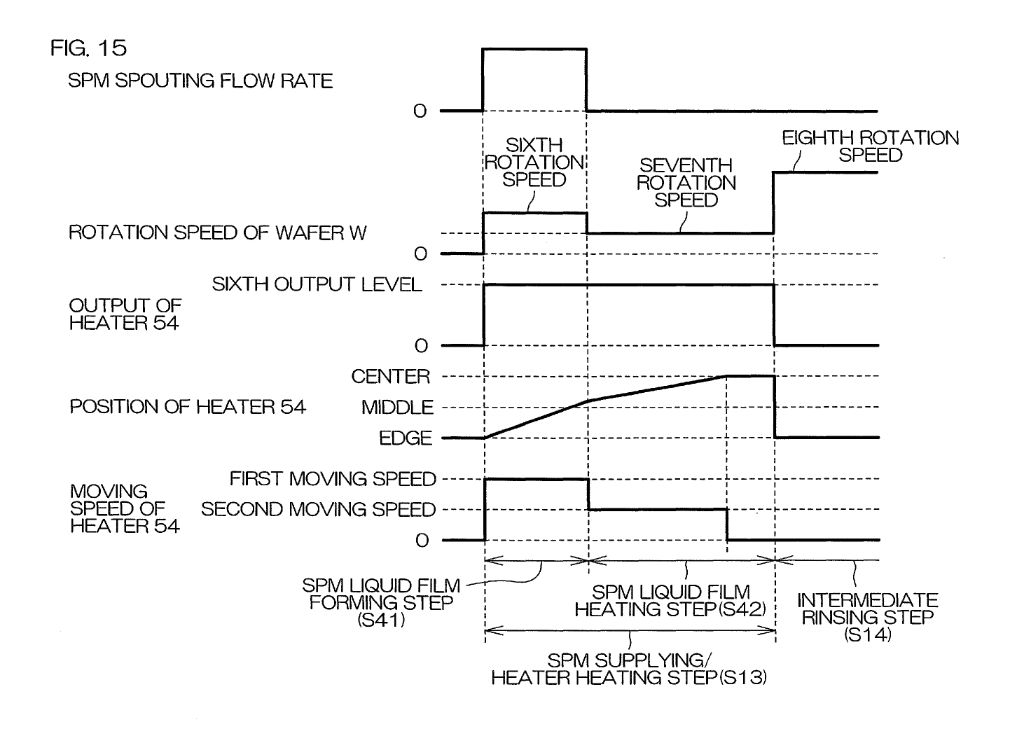

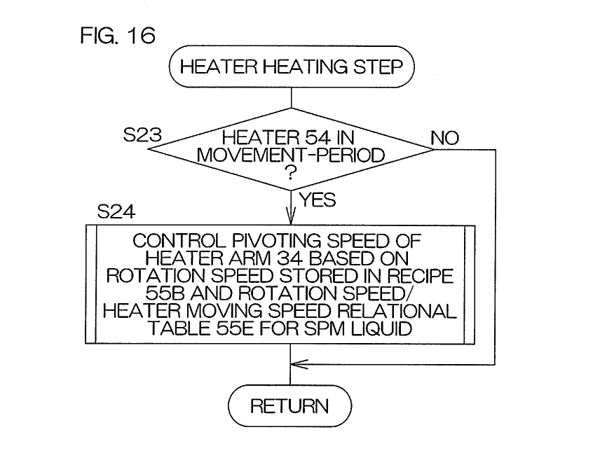

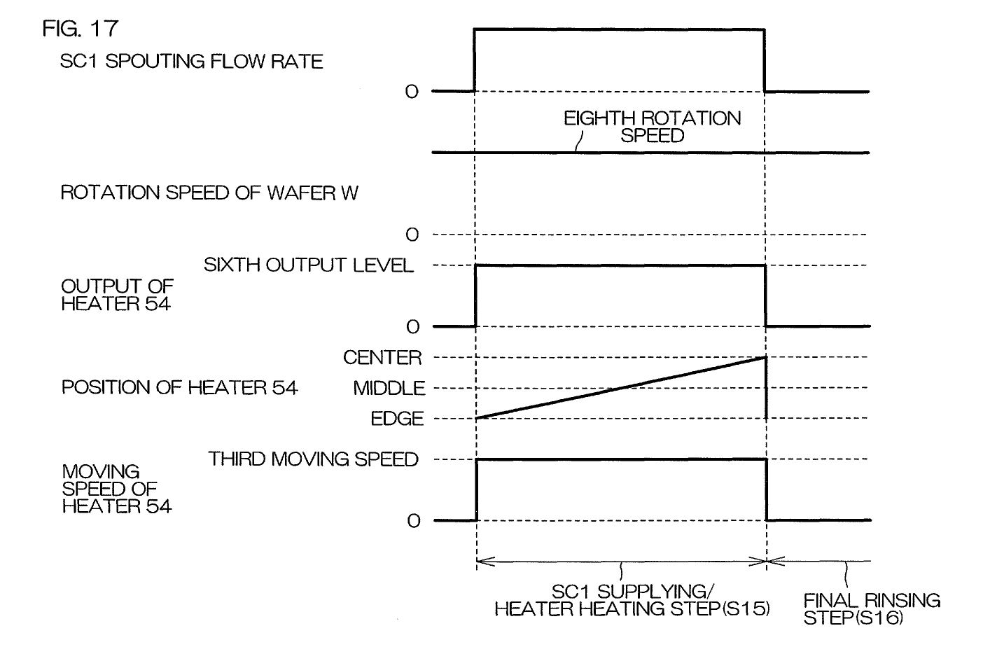

FIG. 14 is a flowchart showing a third exemplary resist removing process according to the second embodiment of the present invention. FIG. 15 is a time chart for explaining an SPM liquid film forming step and an SPM liquid film heating step of the third exemplary process. FIG. 16 is a flow chart showing how to control the moving speed of the heater 54. FIG. 17 is a time chart for explaining an SC1 supplying/heater heating step of the third exemplary process.

Referring to FIGS. 1A and 1B and FIGS. 13 to 17, the third exemplary resist removing process will hereinafter be described.

Prior to the resist removing process, the user operates the recipe inputting portion 57 to determine the recipe 55B to specify conditions for the treatment of the wafer W. Subsequently, the CPU 55A of the computer 155 performs a process sequence for the treatment of the wafer W based on the recipe 55B.

The CPU 55A controls the indexer robot IR (see FIG. 1A) and the center robot CR (see FIG. 1A) to load a wafer W subjected to the ion implantation process into the treatment chamber 2 (Step S11: Wafer loading step). The wafer W is not subjected to the resist ashing process. The wafer W is transferred to the wafer holding mechanism 3 with its front surface facing up. At this time, the heater 54, the lift-off liquid nozzle 4 and the SC1 nozzle 25 are respectively located at their home positions so as not to prevent the loading of the wafer W.

With the wafer W held by the wafer holding mechanism 3, the CPU 55A controls the rotative drive mechanism 6 to start rotating the wafer W (Step S12). As shown in FIG. 15, the rotation speed of the wafer W is increased to a predetermined sixth rotation speed, and then maintained at the sixth rotation speed. The sixth rotation speed is such that the entire front surface of the wafer W can be covered with the SPM liquid, and may be, for example, 150 rpm which is equal to the first rotation speed (see FIG. 8) in the first exemplary process of the first embodiment described above.

As in the first exemplary process of the first embodiment, the CPU 55A controls the first liquid arm pivot mechanism 12 to move the lift-off liquid nozzle 4 to above the wafer W and locate the lift-off liquid nozzle 4 above the rotation center of the wafer W (on the rotation axis A1). Further, the CPU 55A opens the sulfuric acid valve 18, the hydrogen peroxide solution valve 20 and the lift-off liquid valve 23 to supply the SPM liquid from the lift-off liquid nozzle 4 to the front surface of the wafer W (Step S41: SPM liquid film forming step).

The SPM liquid supplied to the front surface of the wafer W spreads from a center portion of the front surface of the wafer W to a peripheral portion of the front surface of the wafer W by a centrifugal force generated by the rotation of the wafer W. Thus, the SPM liquid spreads over the entire front surface of the wafer W to form a liquid film of the SPM liquid which covers the entire front surface of the wafer W. The SPM liquid film has a thickness of, for example, 0.4 mm.

As shown in FIG. 15, the CPU 55A controls the pivot drive mechanism 36 and the lift drive mechanism 37 to move the heater 54 to above the edge adjacent position (indicated by the two-dot-and-dash line in FIG. 5) from the home position defined on the lateral side of the wafer holding mechanism 3 and then down to the edge adjacent position, and further move the heater 54 at a first moving speed in one direction toward the center adjacent position (indicated by the one-dot-and-dash line in FIG. 5).

The SPM liquid film forming step of Step S41 and an SPM liquid film heating step of Step S42 to be described below are collectively referred to as an SPM supplying/heater heating step (Step S13). Throughout the SPM supplying/heater heating step of Step S13, the heater 54 emits infrared radiation. In this embodiment, the output of the heater 54 is set at a fixed output level (sixth output level). The sixth output level is, for example, higher than the first output level (see FIG. 8) employed in the first embodiment described above.

In the SPM liquid film forming step of Step S41, as shown in FIG. 16, the CPU 55A judges if the heater 54 is currently in a movement period, with reference to the timer (not shown) for monitoring the progression status of the resist removing process as in the first exemplary process of the first embodiment (Step S23).

If the heater 54 is in the movement period (YES in Step S23), the CPU 55A determines the pivoting speed of the heater arm 34 based on the rotation speed of the wafer W stored in the recipe 55B and the rotation speed/heater moving speed relational table 55E for the SPM liquid, and controls the pivot drive mechanism 36 to move the heater arm 34 at the pivoting speed thus determined. That is, the moving speed of the heater 54 (the pivoting speed of the heater arm 34) is generally constant, but is changed during the movement period of the heater 54 by thus controlling the pivot drive mechanism 36. The SPM liquid film present on the front surface of the wafer W can be heated to a higher temperature by the infrared radiation emitted from the heater 54. Thus, even a resist having a hardened surface layer can be removed from the front surface of the wafer W without ashing thereof.

If the heater 54 is not in the movement period (NO in Step S23), on the other hand, the CPU 55A does not control the pivot drive mechanism 36.

In the SPM supplying/heater heating step of Step S13, the moving speed of the heater 54 is thus controlled to the moving speed suitable for the rotation speed of the wafer W stored in the recipe 55B. In the SPM liquid film forming step of Step S41, the rotation speed of the wafer W is the relatively high sixth rotation speed, so that a relatively thin SPM liquid film is formed on the front surface of the wafer W. Therefore, the CPU 55A controls the moving speed of the heater 54 to the relatively high first moving speed (e.g., 5 mm/min) based on a relationship between the rotation speed of the wafer W and the moving speed of the heater 54 specified in the rotation speed/heater moving speed relational table 55E for the SPM liquid (see FIG. 13).

The first moving speed of the heater 54 is such that sufficient heat can reach a portion of the SPM liquid film present around the interface between the front surface of the wafer W and the SPM liquid film without damaging the front surface of the wafer W. This prevents the overheating of the front surface of the wafer W and the insufficient heating of the SPM liquid film. As a result, the resist can be efficiently lifted off from the front surface of the wafer W without damaging the front surface of the wafer W in the SPM liquid film forming step of Step S41.

After a lapse of a predetermined SPM liquid supply period from the start of the supply of the SPM liquid, the CPU 55A closes the sulfuric acid valve 18, the hydrogen peroxide solution valve 20 and the lift-off liquid valve 23 to stop supplying the SPM liquid from the lift-off liquid nozzle 4 as shown in FIGS. 1B and 15. Further, the CPU 55A controls the first liquid arm pivot mechanism 12 to move the lift-off liquid nozzle 4 back to its home position after the stop of the supply of the SPM liquid. The SPM liquid supply period should be longer than a period required for forming the SPM liquid film to cover the entire front surface of the wafer W. The SPM liquid supply period varies depending on the spouting flow rate of the SPM liquid spouted from the lift-off liquid nozzle 4 and the rotation speed (sixth rotation speed) of the wafer W, but may be in a range of 3 seconds to 30 seconds, e.g., 15 seconds.

The CPU 55A controls the rotative drive mechanism 6 to reduce the rotation speed of the wafer W from the sixth rotation speed to a seventh rotation speed. The seventh rotation speed is, for example, such that a thicker SPM liquid film can be retained on the front surface of the wafer W even without additional supply of the SPM liquid to the front surface of the wafer W (in a range of 1 rpm to 30 rpm, e.g., 15 rpm). At this time, the SPM liquid film has a thickness of, for example, 1.0 mm.

The CPU 55A continues the emission of the infrared radiation from the heater 54 and, in this state, reduces the moving speed of the heater 54 from the first moving speed to a second moving speed (e.g., 2.5 mm/min) according to a change in the rotation speed of the wafer W (Step S42: SPM liquid film heating step).

In the SPM liquid film heating step of Step S42, the moving speed of the heater 54 is determined based on the rotation speed of the wafer W and the rotation speed/heater moving speed relational table 55E for the SPM. Then, the CPU 55A controls the pivot drive mechanism 36 to move the heater 54 at the moving speed thus determined. In the SPM liquid film heating step of Step S42, more specifically, the rotation speed of the wafer W is the seventh rotation speed that is lower than the sixth rotation speed. Therefore, a thicker SPM liquid film is formed on the front surface of the wafer W than when the wafer W is rotated at the sixth rotation speed. As described above, the rotation speed/heater moving speed relational table 55E for the SPM specifies a relationship between the rotation speed of the wafer W and the moving speed of the heater 54 such that the moving speed of the heater 54 is reduced as the rotation speed of the wafer W decreases. Therefore, the CPU 55A controls the moving speed of the heater 54 to the second moving speed.

The second moving speed of the heater 54 is such that sufficient heat can reach the entire SPM liquid film present around the interface between the front surface of the wafer W and the SPM liquid film without damaging the front surface of the wafer W. This prevents the overheating of the front surface of the wafer W and the insufficient heating of the SPM liquid film. As a result, the resist can be efficiently lifted off from the front surface of the wafer W without damaging the front surface of the wafer W in the SPM liquid film heating step of Step S42.

Immediately after the start of the SPM liquid film heating step of Step S42, the heater 54 is located around the middle adjacent position (indicated by the solid line in FIG. 5) in this embodiment. The CPU 55A controls the pivot drive mechanism 36 to move the heater 54 at the second moving speed from the middle adjacent position toward the center adjacent position (indicated by the one-dot-and-dash line in FIG. 5).

After the heater 54 reaches the center adjacent position, the heating of the wafer W is continued at the center adjacent position for a predetermined period. In the SPM liquid film heating step of Step S42, a portion of the wafer W opposed to the bottom plate 52 of the heater head 35 and the SPM liquid film present on that portion of the wafer W are heated by the infrared radiation emitted from the heater 54. The SPM liquid film heating step of Step S42 is performed for a predetermined heating period (in a range of 2 second to 90 seconds, e.g., about 40 seconds).

After a lapse of a predetermined period from the start of the emission of the infrared radiation from the heater 54, the CPU 55A closes the sulfuric acid valve 18 and the hydrogen peroxide solution valve 20, and controls the heater 54 to stop the emission of the infrared radiation. Further, the CPU 55A controls the pivot drive mechanism 36 and the lift drive mechanism 37 to move the heater 54 back to its home position.

Then, as shown in FIG. 15, the CPU 55A controls the rotative drive mechanism 6 to increase the rotation speed of the wafer W to a predetermined eighth rotation speed, and opens the DIW valve 27 to supply the DIW from the spout of the DIW nozzle 24 toward around the rotation center of the wafer W (Step S14: Intermediate rinsing step). The eighth rotation speed is in a range of 300 rpm to 1500 rpm, e.g., 1000 rpm.

The DIW supplied onto the front surface of the wafer W receives a centrifugal force generated by the rotation of the wafer W to flow toward the peripheral edge of the wafer W on the front surface of the wafer W. Thus, SPM liquid adhering to the front surface of the wafer W is rinsed away with the DIW. After the supply of the DIW is continued for a predetermined period, the CPU 55A closes the DIW valve 27 to stop supplying the DIW to the front surface of the wafer W.

While maintaining the rotation speed of the wafer W at the eighth rotation speed, as shown in FIG. 17, the CPU 55A opens the SC1 valve 31 to supply the SC1 from the SC1 nozzle 25 to the front surface of the wafer W (Step S15: SC1 supplying/heater heating step). The CPU 55A controls the second liquid arm pivot mechanism 29 to pivot the second liquid arm 28 within the predetermined angular range to reciprocally move the SC1 nozzle 25 between a position above the rotation center of the wafer W and a position above the peripheral edge of the wafer W. Thus, an SC1 supply position on the front surface of the wafer W to which the SC1 is supplied from the SC1 nozzle 25 is reciprocally moved along an arcuate path crossing the wafer rotating direction in a range from the rotation center of the wafer W to the peripheral edge of the wafer W. Thus, the SC1 spreads over the entire front surface of the wafer W, whereby a thin liquid film of the SC1 is formed as covering the entire front surface of the wafer W.

The front surface of the wafer W and the SC1 liquid film are warmed by the heater 54 during the supply of the SC1 to the wafer W. As in the SPM supplying/heater heating step of Step S13, the CPU 55A controls the heater 54 to start emitting the infrared radiation, and controls the pivot drive mechanism 36 and the lift drive mechanism 37 to move the heater 54 from the home position defined on the lateral side of the wafer holding mechanism 3 to above the edge adjacent position (indicated by the two-dot-and-dash line in FIG. 5) and then down to the edge adjacent position, and move the heater 54 toward the center adjacent position (indicated by the one-dot-and-dash line in FIG. 5) at a constant speed.

In the SC1 supplying/heater heating step of Step S15, the output level of the heater 54 is fixed to the sixth output level.

In the SC1 supplying/heater heating step of Step S15, the method of scanning the SC1 nozzle 25 and the heater 54 is determined so as to prevent the SC1 nozzle 25 and the heater 54 from interfering with each other.

The CPU 55A moves the heater 54 to above the edge adjacent position and then down to the edge adjacent position, and moves the heater 54 toward the center adjacent position (indicated by the one-dot-and-dash line in FIG. 5) at a predetermined third moving speed.

In the SC1 supplying/heater heating step of Step S15, the moving speed of the heater 54 is determined based on the rotation speed of the wafer W and the rotation speed/heater moving speed relational table 55G for the SC1. Then, the CPU 55A controls the pivot drive mechanism 36 to move the heater 54 at the moving speed thus determined. In the SC1 supplying/heater heating step of Step S15, the rotation speed of the wafer W is kept constant at the eighth rotation speed. The moving speed of the heater 54 is controlled to the constant third moving speed suitable for the rotation speed of the wafer W.

The third moving speed is such that sufficient heat can reach the SC1 liquid film portion present around the interface between the front surface of the wafer W and the SC1 liquid film without damaging the front surface of the wafer W in the SC1 supplying/heater heating step of Step S15.

In the SC1 supplying/heater heating step of Step S15, the SC1 is evenly supplied to the entire front surface of the wafer W, whereby particles adhering to the front surface of the wafer W can be efficiently removed for cleaning the front surface of the wafer W. The SC1 is heated by the heater 54 and, therefore, is highly activated. As a result, the cleaning efficiency can be significantly improved.

In the SC1 supplying/heater heating step of Step S15, the moving speed of the heater 54 is controlled to the third moving speed, thereby preventing the overheating of the front surface of the wafer W and the insufficient heating of the SC1 liquid film. As a result, the front surface of the wafer W can be cleaned without any damage thereto in the SC1 supplying/heater heating step of Step S15.

In this embodiment, the rotation speed of the wafer W is not changed in the SC1 supplying/heater heating step of Step S15 and, therefore, the output of the heater 54 is not changed in the SC1 supplying/heater heating step. Where the rotation speed of the wafer W is changed in the SC1 supplying/heater heating step, however, the output of the heater 54 is changed according to the change in the rotation speed.

After the heating by the heater 54 is continued for a predetermined period, the CPU 55A controls the heater 54 to stop emitting the infrared radiation, and controls the pivot drive mechanism 36 and the lift drive mechanism 37 to move the heater 54 back to its home position.

After the supply of the SC1 is continued for a predetermined period, the CPU 55A performs a final rinsing step of Step S16, a drying step of Step S17 and a wafer unloading step of Step S18 in the same manner as the final rinsing step of Step S6, the drying step of Step S7 and the wafer unloading step of Step S8 of the first embodiment.

According to this embodiment, as described above, the heater 54 is moved along the front surface of the wafer W by the pivot drive mechanism 36 in the SPM liquid film forming step of Step S41, the SPM liquid film heating step of Step S42 and the SC1 supplying/heater heating step of Step S15. The moving speed of the heater 54 is adjusted according to the rotation speed of the wafer W. Therefore, the moving speed of the heater 54 can be adapted for the thickness of the liquid film present on the front surface of the wafer W. That is, the amount of the heat to be applied to the predetermined portion of the liquid film of the treatment liquid (the SPM liquid or the SC1) can be relatively reduced by increasing the moving speed of the heater 54. On the other hand, the amount of the heat to be applied to the predetermined liquid film portion can be relatively increased by reducing the moving speed of the heater 54. Even if the thickness of the liquid film of the treatment liquid (the SPM liquid or the SC1) is changed due to a change in the rotation speed of the wafer W, therefore, the overheating of the front surface of the wafer W and the insufficient heating of the SPM liquid film can be prevented. As a result, the front surface of the wafer W can be advantageously treated with the use of the heater 54 without any damage thereto.

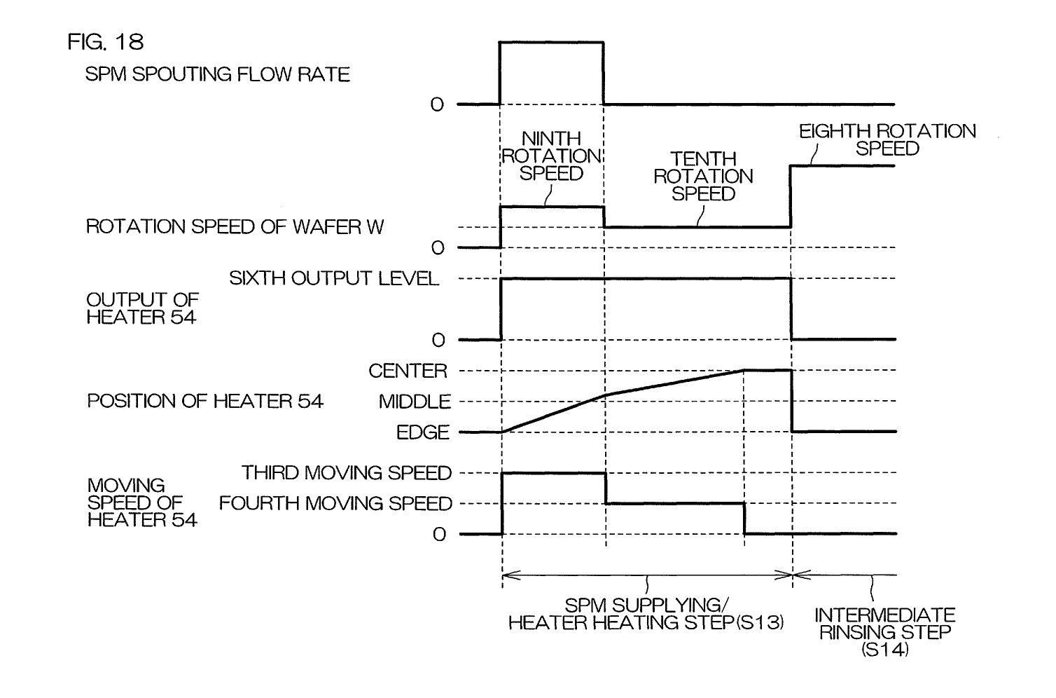

FIG. 18 is a time chart showing a fourth exemplary resist removing process according to the second embodiment of the present invention. In the second embodiment, the fourth exemplary process differs from the third exemplary process in that an SPM supplying/heater heating step of Step S43 shown in FIG. 18 is performed instead of the SPM supplying/heater heating step of Step S13 shown in FIG. 15. Other process steps are performed in the same manner as in the third exemplary process of the second embodiment. Therefore, only the SPM supplying/heater heating step of Step S43 in the fourth exemplary process will be described.

In the SPM supplying/heater heating step of Step S43, the SPM liquid is supplied from the lift-off liquid nozzle 4 to the front surface of the wafer W to cover the front surface of the wafer W with a liquid film of the SPM liquid, and the infrared radiation is emitted from the heater 54 as in the SPM supplying/heater heating step of Step S13. However, the supply of the SPM liquid from the lift-off liquid nozzle 4 is continued throughout the period of the emission of the infrared radiation. This differentiates the SPM supplying/heater heating step of Step S43 from the SPM supplying/heater heating step of Step S13 shown in FIG. 15.

In the SPM supplying/heater heating step of Step S43, the wafer W is rotated at a relatively high rotation speed (ninth rotation speed) for a predetermined period (for example, corresponding to the SPM liquid supply period in the third exemplary process), and then rotated at a relatively low tenth rotation speed lower than the ninth rotation speed for a predetermined period (for example, corresponding to the liquid film heating period in the third exemplary process) as in the SPM supplying/heater heating step of Step S13. The ninth rotation speed is such that the entire front surface of the wafer W can be covered with the SPM liquid, and may be, for example, 150 rpm which is equal to the sixth rotation speed in the third exemplary process described above.

In the fourth exemplary process, when the rotation speed of the wafer W is the relatively high ninth rotation speed, the moving speed of the heater 54 is controlled to a relatively high third moving speed. When the wafer W is rotated at the relatively high ninth rotation speed, a relatively thin SPM liquid film is formed on the front surface of the wafer W. However, the third moving speed is such that sufficient heat can reach the SPM liquid film portion present around the interface between the front surface of the wafer W and the SPM liquid film without damaging the front surface of the wafer W.

When the rotation speed of the wafer W is the relatively low tenth rotation speed (e.g., not lower than 15 rpm), the moving speed of the heater 54 is controlled to a fourth moving speed that is lower than the third moving speed. When the rotation speed of the wafer W is changed to the relatively low tenth rotation speed, the thickness of the SPM liquid film is increased. The fourth moving speed of the heater 54 is such that sufficient heat can reach the SPM liquid film portion present around the interface between the front surface of the wafer W and the SPM liquid film on the front surface without damaging the front surface of the wafer W.

The tenth rotation speed is lower than the ninth rotation speed and higher than the seventh rotation speed of the third exemplary process described above. Thus, a thicker SPM liquid film is formed on the front surface of the wafer W than when the wafer W is rotated at the ninth rotation speed. The tenth rotation speed is required to be, for example, such that the SPM liquid film can be retained on the front surface of the wafer W.

Thus, the fourth exemplary process employing the SPM supplying/heater heating step of Step S43 provides effects comparable to those of the third exemplary process described above.

While two embodiments of the present invention have thus been described, the invention may be embodied in other ways.

For example, a rotation speed/heater output/hater moving speed relational table specifying a relationship among the rotation speed of the wafer W, the output of the heater 54 and the moving speed of the heater 54 may be stored in the storage 55D, and the CPU 55A may be adapted to determine the output of the heater 54 and the moving speed of the heater 54 based on the rotation speed of the wafer W with reference to the table.

In the SPM supplying/heater heating steps of Steps S3, S13, S33, S43 and the SC1 supplying/heater heating steps of Steps S5 and S15, the heater 54 is moved at the constant moving speed in one direction from the edge adjacent position (indicated by the two-dot-and-dash line in FIG. 5) toward the center adjacent position (indicated by the one-dot-and-dash line in FIG. 5) by way of example. Alternatively, the heater 54 may be reciprocally moved at a predetermined moving speed between the edge adjacent position (indicated by the two-dot-and-dash line in FIG. 5) and the center adjacent position (indicated by the one-dot-and-dash line in FIG. 5). In this case, the heater 54 may be moved at different moving speeds in opposite reciprocal directions. In this case, a rotation speed/heater moving speed relational table specifying different moving speeds for the opposite reciprocal directions may be stored in the storage 55D.

The infrared lamp 38 including the single annular lamp is used by way of example but not by way of limitation. Alternatively, the infrared lamp 38 may include a plurality of annular lamps disposed coaxially with each other, or may include a plurality of linear lamps disposed parallel to each other in a horizontal plane.

In the embodiments described above, the resist removing process is performed on the wafer W by way of example, but the present invention is applicable to an etching process typified by a phosphoric acid etching process. In this case, etching liquids such as a phosphoric acid aqueous solution and a hydrofluoric acid aqueous solution, and cleaning chemical liquids such as SC1 and SC2 (hydrochloric acid/hydrogen peroxide mixtures) may be used as the treatment liquid.

While the present invention has been described in detail by way of the embodiments thereof, it should be understood that these embodiments are merely illustrative of the technical principles of the present invention but not limitative of the invention. The spirit and scope of the present invention are to be limited only by the appended claims.

This application corresponds to Japanese Patent Application No. 2013-187626 filed in the Japan Patent Office on Sep. 10, 2013, the disclosure of which is incorporated herein by reference in its entirety.

What is claimed is:

1. A substrate treatment method comprising:
a treatment liquid supplying step of supplying a treatment liquid to a major surface of a substrate;
a substrate rotating step of rotating the substrate while retaining a liquid film of the treatment liquid on the major surface of the substrate;
a heater heating step of locating a heater in opposed relation to the major surface of the substrate to heat the treatment liquid film by the heater in the substrate rotating step; and
a heat amount controlling step of controlling an amount of heat to be applied per unit time to a predetermined portion of the liquid film from the heater according to a rotation speed of the substrate in the heater heating step.

2. The substrate treatment method according to claim 1, wherein the heat amount controlling step includes a heater output controlling step of controlling an output of the heater according to the rotation speed of the substrate.

3. The substrate treatment method according to claim 1, further comprising a heater moving step of moving the heater along the major surface of the substrate,
wherein the heat amount controlling step includes a heater moving speed controlling step of controlling a moving speed of the heater according to the rotation speed of the substrate.

4. The substrate treatment method according to claim 1, wherein the heat amount controlling step includes the step of determining the heat amount per unit time based on a relational table indicating a relationship between the rotation speed of the substrate and the amount of the heat to be applied per unit time from the heater.

5. The substrate treatment method according to claim 1, wherein the heat amount controlling step includes the step of referring to a recipe stored in a recipe storing unit and determining the heat amount per unit time based on a rotation speed of the substrate specified in the recipe to be employed in the substrate rotating step.

6. The substrate treatment method according to claim 1, wherein the treatment liquid includes a resist lift-off liquid containing sulfuric acid.

7. The substrate treatment method according to claim 1, wherein the treatment liquid includes a chemical liquid containing an ammonia water.

8. A substrate treatment apparatus comprising:
a substrate holding unit which holds a substrate;
a substrate rotating unit which rotates the substrate held by the substrate holding unit;
a treatment liquid supplying unit which supplies a treatment liquid to a major surface of the substrate held by the substrate holding unit;
a heater to be located in opposed relation to the major surface of the substrate; and
a control unit which controls the substrate rotating unit and the heater to perform a substrate rotating step of rotating the substrate while retaining a liquid film of the treatment liquid on the major surface of the substrate, a heater heating step of heating the treatment liquid film by the heater in the substrate rotating step, and a heat amount controlling step of controlling an amount of heat to be applied per unit time to a predetermined portion of the liquid film from the heater according to a rotation speed of the substrate in the heater heating step.
